(19) United States
(12) Patent Application Publication
(10) Pub. No.: US 2013/0034822 A1
(43) Pub. Date: Feb. 7, 2013

(54) ORTHODONTIC ATTACHMENT DEVICE SYSTEMS AND METHODS

(71) Applicant: Russell C. Teasdale, Portland, OR (US)

(72) Inventor: Russell C. Teasdale, Portland, OR (US)

(21) Appl. No.: 13/645,483

(22) Filed: Oct. 4, 2012

Related U.S. Application Data
(63) Continuation of application No. PCT/US2011/028001, filed on Mar. 10, 2011.
(60) Provisional application No. 61/329,557, filed on Apr. 29, 2010.

(51) Int. Cl. A61C 7/08

(52) U.S. Cl. 433/6

(57) ABSTRACT

Embodiments presented herein are directed to accurately coupling attachment devices to dental surfaces suitable for cooperative engagement with positioning appliances. In accordance with an embodiment, a system is provided that comprises a template, one or more preformed attachment devices, and one or more gaskets. The template is operable for accurate locating and positioning of the preformed attachment device onto the tooth surface. The gasket is operable to mask unintended tooth surface adjacent the preformed attachment device from bonding material. The preformed attachment device is operable to facilitate secure bonding to the tooth surface via bonding material.

### RELATED APPLICATIONS

This application is a continuation of and claims priority to PCT patent application Serial Number PCT/US11/28001, filed Mar. 10, 2011, entitled ORTHODONTIC ATTACHMENT SYSTEMS AND METHODS, incorporated herein in its entirety by reference, which is a non-provisional application claiming the benefit of U.S. Provisional Application No. 61/329,557, filed Apr. 29, 2010, incorporated herein in its entirety by reference.

### FIELD

The present invention is related generally to the field of orthodontics. More particularly, the present invention involves systems and methods that enable accurate formation and placement of attachment devices on a dental surface for a patient undergoing orthodontic treatment.

### BACKGROUND

Orthodontic treatment involves the repositioning of misaligned teeth and improving bite configurations for improved dental function and cosmetic appearance. Repositioning teeth may be accomplished by applying controlled forces to the teeth over an extended period of time. A number of systems and techniques are known for applying the required forces to the teeth.

One known method for applying forces to the teeth is by the use of elastic positioning appliances as described by Chishti et al. in U.S. Pat. No. 5,975,893. Such positioning appliances comprise a thin shell of elastic material that generally conforms to a patient's teeth but is slightly out of alignment with the initial tooth position. Placement of the positioning appliance over the teeth applies controlled forces to the teeth to gradually move the teeth into a new position. Repetition of this process with successive positioning appliances comprising new teeth positions eventually moves the teeth through a series of intermediate positions to a final desired position.

When the positioning appliance is placed over a prescribed group of teeth, one or more of the teeth may provide an anchor for holding the appliance in place while the stiffness of the appliance imparts a positioning force against at least a portion of the target teeth.

The anchoring and repositioning abilities of positioning appliances are dependent at least in part on the physical features and positions of the patient's teeth, previous dental work, and the like. Among other things, these physical features may not be optimally suitable for providing an optimal force bearing surface for anchoring or applying positioning forces to the teeth by the positioning appliance. For example, but not limited thereto, positioning appliances may have difficulty applying certain forces to individual teeth, such as extrusive forces (e.g., pulling or raising a tooth relative to the jaw).

Attempts to augment the force transfer between the positioning appliance and the teeth have been attempted, such as those described by Phan et al. in U.S. Pat. No. 7,125,248. Phan et al. describes the use of attachment devices that are bonded to one or more teeth or other dental feature so as to provide an enhanced surface upon which the positioning appliance may bear. Phan et al. describes a method of forming and bonding the attachment device to the teeth with the use of a mold. The mold is substantially in the form of the positioning appliance, which substantially conforms to the teeth, but has one or more negative impressions having a shape that is complementary to the desired attachment device. Malleable polymerizing material is placed in the negative impression and the mold is slidingly received over the teeth. The polymerizing material is cured such that when the mold is removed from the teeth, the now polymerized material forms the attachment device that, if successful, is bonded to the tooth. This method is referred herein as the mold-in-place approach.

In practice, the mold-in-place approach as provided by Phan et al. has a number of shortcomings. One shortcoming, among others, is that a precise amount of the polymerizing material must be disposed within the respective negative impression prior to placement onto the teeth, otherwise the negative impression may be underfilled or overfilled. An underfilled negative impression may lead to, among other things, an underdeveloped or malformed attachment device that is not suitable for the intended purpose. Further, an underfilled negative impression may lead to, among other things, the polymerizing material making only partial or insufficient contact with the tooth surface thereby resulting in an attachment device that is partially or insufficiently bonded to the tooth. Ensuring full contact between the polymerizing material and the tooth surface is further complicated by the necessity of using a very viscous polymerizing material. The polymerizing material must be very viscous so that, among other things, the polymerizing material stays substantially within the negative impression during handling of the mold and in placement on the teeth. Being very viscous or putty-like, the polymerizing material may not flow towards the tooth surface and make full contact therewith prior to curing resulting in a poorly bonded or not bonded attachment device.

An overfilled negative impression may lead to, among other things, an ill-fitting, distorted mold. An overfilled negative impression may, among other things, not seat properly on the tooth surface so as to not position the polymerizing material at the intended location or may form a malformed attachment device after cure. The mold may have to be forcibly held in place on the teeth to ensure that it is properly seated thereon during the curing process.

An overfilled negative impression may lead to, among other things, flashing. Flashing is excess polymerizing material that may deposit on unintended tooth surfaces or beyond the prescribed footprint of the attachment device. The excess material may be unintentionally deposited on the tooth surface when the mold is slidingly received onto the teeth. The excess material may extrude away from the negative impression when pressure is exerted onto the mold during placement and cure of the polymerizing material. Flashing must be removed to allow for proper placement of the positioning appliance onto the teeth. Flashing has the potential to cause, among other things, the positioning appliance to not seat properly on the teeth and may cause unintentional forces on the teeth resulting in improper repositioning. Removing flashing is labor and time intensive and may lead to damage to the resulting attachment device or undesirable modification of the underlying tooth surface to which it is attached.

A precisely formed attachment device is crucial for optimal performance of the positioning appliance. The shape of the positioning appliance is predetermined taking into account the precise position and shape of any attachment devices that may be provided. A malformed or misplaced attachment device may lead to, among other things, a malfitting positioning appliance that may result in non-prescribed or inefficient expressions of intended forces acting on one or more teeth resulting in unpredictable and undesired repositioning of the teeth.

The consequences of improperly formed attachment devices, among other things, may lead to an interruption in the proposed intended sequence of the treatment plan of the use of progressive positioning appliances. Positioning appliances are created and supplied by the manufacturer as a sequential set with the expectation that the attachment devices are properly formed. In many cases, the imprecise placement and formation of the attachment devices results in, among other things, inappropriate repositioning of the teeth prolonging the treatment and requiring the manufacture of additional positioning appliances to reposition or fine-tune the repositioning of the teeth which increases the cost of materials and patient and doctor time.

It would therefore be desirable to provide apparatus and methods for forming and positioning attachment devices that address one or more of these shortcomings.

### SUMMARY

Embodiments presented herein provide apparatus and methods for coupling an attachment device onto one or more teeth. In accordance with an embodiment, a system is provided that comprises a template, one or more preformed attachment devices, and one or more gaskets. Each of the one or more preformed attachment devices comprise a surface for receiving bonding material suitable for coupling the preformed attachment device to a tooth surface. Each of the one or more gaskets comprises a gasket first surface and a gasket second surface opposite the gasket first surface. The gasket further comprises a gasket aperture extending from the gasket first surface to the gasket second surface therethrough for receiving one of the one or more preformed attachment devices therein. The template comprises a cavity being operable to receive one or more teeth. The template further comprises an attachment receiving element and a gasket cavity at one or more predetermined locations, each attachment receiving element being operable to receive one of the one or more preformed attachment devices therein, and each gasket cavity being operable to receive one of the one or more gaskets therein. The template comprises means for advancing each gasket into engagement with the tooth surface to affect a substantially fluid-sealing engagement therebetween with the gasket aperture defining target tooth surface. Each preformed attachment device may be advanced into engagement with the target tooth surface to affect coupling therewith via bonding material.

In accordance with an embodiment, a method for coupling an attachment device on one or more teeth is provided. The method comprises: preparing tooth surface to receive a gasket and bonding material; providing a template comprising a prescribed number and placement of attachment receiving cavities and gasket cavities; disposing a preformed attachment device into each of the attachment receiving cavities; disposing and coupling a gasket to each of the gasket cavities; disposing bonding material onto a surface of the preformed attachment device; placing the template onto the teeth; engaging each gasket with the tooth surface in a substantially fluid-sealing engagement therebetween, a gasket aperture of the gasket defining target tooth surface; advancing the preformed attachment device to the target tooth surface such that the bonding material engages the target tooth surface; curing the bonding material to a hardened state so as to couple the preformed attachment device to the target tooth surface; removing the template from the teeth; removing each gasket from the respective preformed attachment device and the teeth; and removing any flash.

Embodiments presented herein provide apparatus and methods for forming and coupling an attachment device onto one or more teeth. In accordance with an embodiment, a system is provided that comprises a template and one or more gaskets. The template comprises a shell having a cavity defining a shape operable to receive one or more teeth. The template includes a template inner surface and a template outer surface opposite the template inner surface. Each gasket comprises a gasket first surface and a gasket second surface opposite the gasket first surface. The gasket includes a gasket aperture having a gasket inner wall extending from the gasket first surface to the gasket second surface therethrough. The gasket further comprises a first adhesive layer on the gasket first surface, the first adhesive layer being operable for removably coupling the gasket to a tooth surface in a substantially fluid-sealing engagement therebetween. The template further comprises a mold cavity at one or more predetermined locations. The mold cavity defines a gasket cavity. The gasket cavity defines a stepped concavity of the template inner surface being operable to receive the gasket. Each mold cavity comprises a template aperture extending from the template inner surface to the template outer surface therethrough. The gasket cavity is operable to removably couple with and dispose the gasket a predetermined distance away from a respective tooth during placement of the template onto the teeth such that the gasket does not come into contact with the tooth surface. The template comprises means for advancing each gasket into engagement with the tooth surface to affect a substantially fluid-sealing engagement therebetween with the gasket aperture defining target tooth surface. The template aperture is operable to permit the deposition of curable material into the mold cavity and gasket aperture and onto the target tooth surface.

In accordance with an embodiment, a method for forming and coupling an attachment device on one or more teeth is provided. The method comprises: providing a template including a prescribed number and placement of mold cavities including gasket cavities; removably coupling a gasket to each respective gasket cavity, wherein the gasket includes a gasket aperture suitable for defining target tooth surface and for forming an attachment device of the desired shape from curable material if the gasket is removably coupled to the tooth; disposing the template over the teeth; removably coupling the gasket first surface to tooth surface in a substantially fluid-sealing engagement therebetween and decoupling the gasket from the gasket cavity with the gasket aperture defining target tooth surface; disposing curable material within the mold cavity and gasket aperture and in contact with the target tooth surface; curing the curable material to a hardened state to form an attachment device that is coupled to the target tooth surface; removing the template; and removing the gasket from the attachment device and tooth.

### BRIEF DESCRIPTION OF THE DRAWINGS

Embodiments are illustrated by way of example and not by way of limitation in the figures of the accompanying drawings, in which like references may indicate similar elements throughout the various figures unless otherwise specified.

FIG. 1 is a perspective view of a system for forming and coupling one or more attachment devices onto one or more teeth, in accordance with an embodiment;

FIG. 2 is a perspective view of an attachment device coupled to a tooth, in accordance with an embodiment;

FIG. 3 is a bottom view of a mold cavity in accordance with an embodiment;

FIG. 4 is a cross-sectional view of the mold cavity along cut-line 4-4 of the embodiment of FIG. 3;

FIG. 5 is a perspective view of a gasket, in accordance with an embodiment;

FIG. 6 is a cross-sectional view of the gasket along cut-line 6-6 of the embodiment of FIG. 5;

FIGS. 7-11 are cross-sectional views of the mold cavity along cut-line 7-7 of the embodiment of FIG. 1, in various stages of using the system in accordance with an embodiment;

FIG. 12 is a perspective view of a cover plate including a plate aperture in accordance with an embodiment;

FIGS. 13-15 are cross-sectional views of an attachment device in various stages of formation, in accordance with embodiments;

FIG. 16 is a flow chart of methods of forming and coupling attachment devices to tooth surfaces in accordance with embodiments;

FIG. 17 is a cross-sectional view of a system for forming and coupling one or more attachment devices onto one or more teeth in accordance with another embodiment;

FIG. 18 is a cross-sectional view of the system in accordance with the embodiment of FIG. 17;

FIG. 19 is a cross-sectional view of an attachment device in a stage of formation, in accordance with embodiments;

FIG. 20 is a cross-sectional view of a system for forming and coupling one or more attachment devices onto one or more teeth in accordance with another embodiment;

FIG. 21 is a perspective view of a system for coupling preformed attachment devices onto one or more teeth, in accordance with an embodiment;

FIGS. 22A and 22B are perspective and side views, respectively, of a preformed attachment device defining a shape of a rounded cube, in accordance with an embodiment;

FIGS. 23A and 23B are perspective and cross-sectional views, along cut line 23B-23B, respectively, of an embodiment of a preformed attachment device defining an attachment cavity in communication with the base via an attachment aperture, in accordance with an embodiment;

FIG. 24 is a cross-sectional view, along cut line 23B-23B, of another embodiment of a preformed attachment device defining an attachment cavity in communication with the base via an attachment aperture including a pressure relief element therein, in accordance with an embodiment;

FIG. 25 is a cross-sectional view of a preformed attachment device further comprising a pressure relief element disposed within an attachment cavity, in accordance with an embodiment;

FIGS. 26A and 26B are cross-sectional views of a preformed attachment device wherein the pressure relief element comprises a compressible material, shown with bonding material disposed thereon, in accordance with an embodiment;

FIGS. 27A and 27B are cross-sectional views of a preformed attachment device wherein the pressure relief element comprises a porous material, shown with bonding material disposed thereon, in accordance with an embodiment;

FIG. 28 is a cross-sectional view of a preformed attachment device wherein the attachment cavity is divided into a first cavity and a second cavity in communication with each other via a cavity aperture, in accordance with an embodiment;

FIG. 29 is a cross-sectional view of a preformed attachment device further comprising a pressure relief aperture defined by the attachment wall, in accordance with an embodiment;

FIGS. 30A-C are various embodiments of preformed attachment devices;

FIG. 31 is a bottom view of the template of the embodiment of FIG. 21;

FIG. 32 is a cross-sectional view of the template at cut line 32-32 of the embodiment of FIG. 31;

FIGS. 33-35 are cross-sectional views of the template, gasket, and preformed attachment device, along cut-line 33-33 shown in FIG. 21, in accordance with an embodiment, in various stages of using the system;

FIG. 36 is a cross-sectional view of a gasket and preformed attachment device, along cut-line 33-33 shown in FIG. 21, in accordance with an embodiment;

FIG. 37 is a cross-sectional view of a gasket and preformed attachment device along cut-line 33-33 shown in FIG. 21, in accordance with an embodiment;

FIG. 38 is a cross-sectional view of the attachment receiving cavity comprising ribs, in accordance with an embodiment;

FIGS. 39-41 are cross-sectional views of the template, gasket, and preformed attachment device, along cut-line 33-33 shown in FIG. 21, in accordance with another embodiment, in various stages of using the system;

FIGS. 42-44 are cross-sectional views of the template, gasket, and preformed attachment device, along cut-line 33-33 shown in FIG. 21, in accordance with another embodiment, in various stages of using the system;

FIGS. 45A, 45B are cross-sectional views of the template, gasket, and preformed attachment device, along cut-line 33-33 shown in FIG. 21, in accordance with another embodiment, in various stages of using the system;

FIGS. 46-48 are cross-sectional views of the template, gasket, and preformed attachment device, along cut-line 33-33 shown in FIG. 21, in accordance with another embodiment, in various stages of using the system;

FIG. 49 is a cross-sectional view of a template, gasket, and preformed attachment device, along cut-line 33-33 shown in FIG. 21, in accordance with another embodiment;

FIG. 50 is a flow chart of methods of coupling preformed attachment devices to tooth surfaces in accordance with embodiments;

FIG. 51 is a perspective view of another system for coupling preformed attachments onto one or more teeth, in accordance with an embodiment;

FIG. 52 is a cross-sectional view of the template at cut line 52-52 of the embodiment of FIG. 51;

FIG. 53 is a cross-sectional view of the template at cut line 53-53 of the embodiment of FIG. 51 including a gasket and a preformed attachment device, in accordance with an embodiment; and

FIG. 54 is a side view of an embodiment of a template showing embodiments of various template apertures associated with corresponding preformed attachment devices in accordance with embodiments.

### DETAILED DESCRIPTION

In the following description, embodiments of apparatus and methods will be disclosed. For purposes of explanation, specific numbers, materials, or configurations are set forth in order to provide a thorough understanding of the embodiments. However, it will also be apparent to those skilled in the art that the embodiments may be practiced without one or more of the specific details, or with other approaches, materials, components, etc. In other instances, well-known structures, materials, or operations are not shown or described in detail to avoid obscuring the embodiments. Accordingly, in some instances, features are omitted or simplified in order to not obscure the disclosed embodiments. Furthermore, it is understood that the embodiments shown in the figures are illustrative representations and are not necessarily drawn to scale.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Reference will now be made to embodiments illustrated in the drawings and specific language which will be used to describe the same. It will nevertheless be understood that no limitation of the scope of the invention is thereby intended. Alterations and further modifications of the illustrated embodiments and further applications of the principles of the invention, as would normally occur to one skilled in the art to which the invention relates, are also within the scope of the invention.

For the purposes of the subject matter disclosed herein, reference to a positioning appliance refers to an appliance, such as, but not limited to, a polymeric shell having cavities with geometries shaped to receive and resiliently reposition from one position to a successive position of one or more teeth, such as, but not limited to, appliances provided in Chishti et al., U.S. Pat. No. 5,975,893. A positioning appliance may also refer to any intraoral appliance, such as, but not limited to, dental wire and elastic dental bands.

For the purposes of the subject matter disclosed herein, reference to an attachment device refers to an element having predetermined dimensions which is coupled to a tooth or restored tooth surface and operable to be engaged by a positioning appliance to enhance the ability of the positioning appliance to exert a controlled orthodontic force on one or more teeth or to increase the retention of the positioning appliance on the teeth.

For the purposes of the subject matter disclosed herein, reference to flash and flashing refers to excess curable material, such as, but not limited to, polymerizing material, that may be unintentionally deposited on the tooth surface or that is outside of the intended shape or profile of the attachment device that may occur during the molding or coupling of the attachment device to the tooth surface, examples of which is shown in FIG. 14, flash 176.

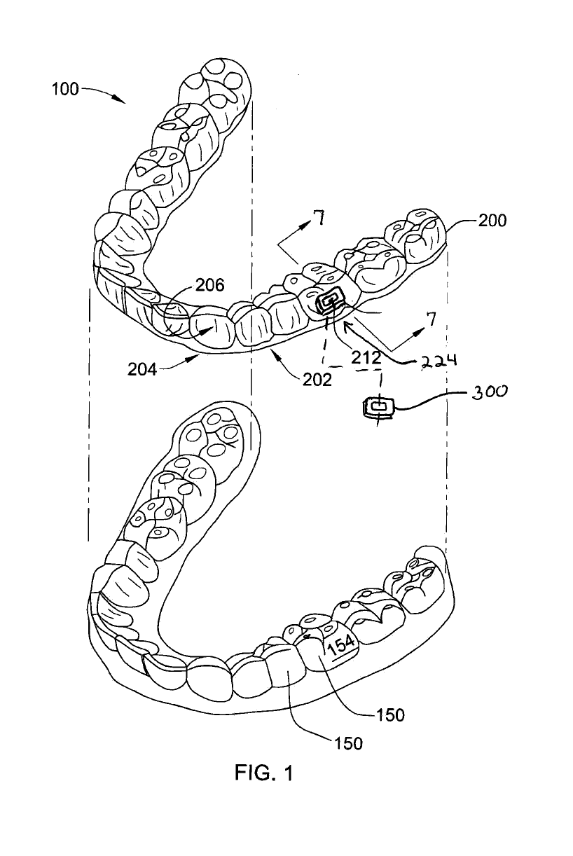

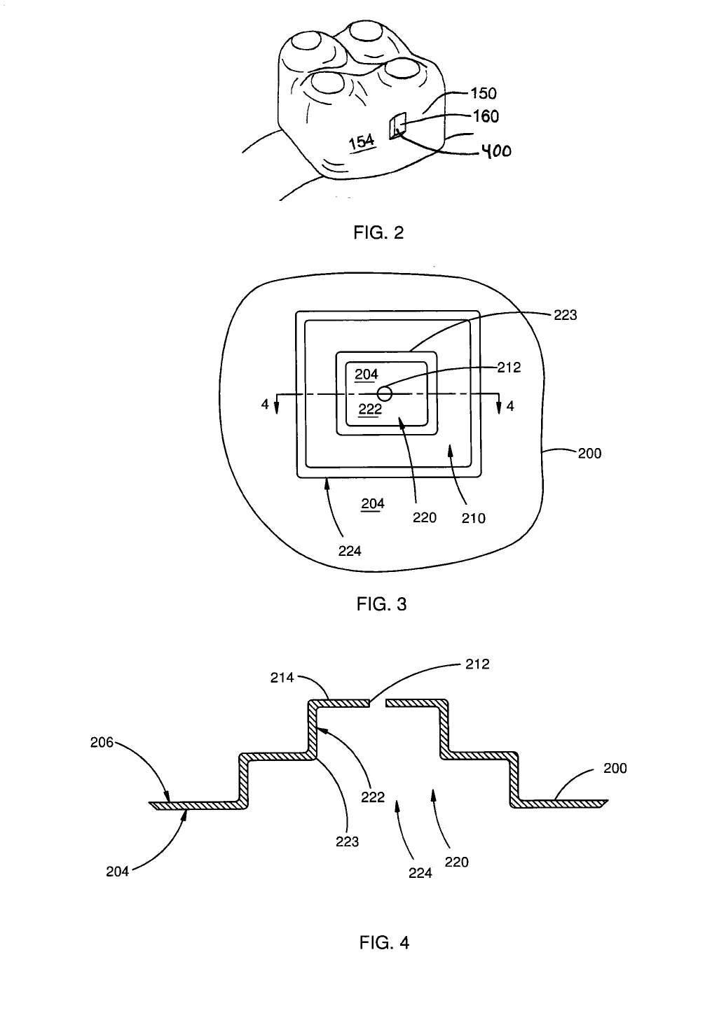

FIG. 1 is a perspective view of a system 100 for forming and coupling attachment devices onto one or more teeth 150, in accordance with an embodiment. FIG. 2 is a perspective view of an attachment device 160 coupled to a tooth 150, in accordance with an embodiment. In FIG. 1, the system 100 comprises a template 200 and one or more gaskets 300.

The system 100 is operable for accurate forming and placement of attachment devices 160 onto the tooth surface 154 without having curable material encroaching on unintended tooth surface 154 adjacent the attachment device 160. The template 200 is operable for accurate locating and positioning of the gasket 300 onto the tooth surface 154 and, in some embodiments, to provide a mold for forming the attachment device 160. The gasket 300 is operable to mask or exclude unintended tooth surface 154 from the curable material 170.

The template 200 comprises a shell having a cavity 202 with a shape operable to receive one or more teeth 150. The template 200 defines a template inner surface 204 and a template outer surface 206 opposite the template inner surface 204. The template 200 is operable to removably engage the teeth 150. The template 200 comprises a mold cavity 224 at one or more predetermined locations.

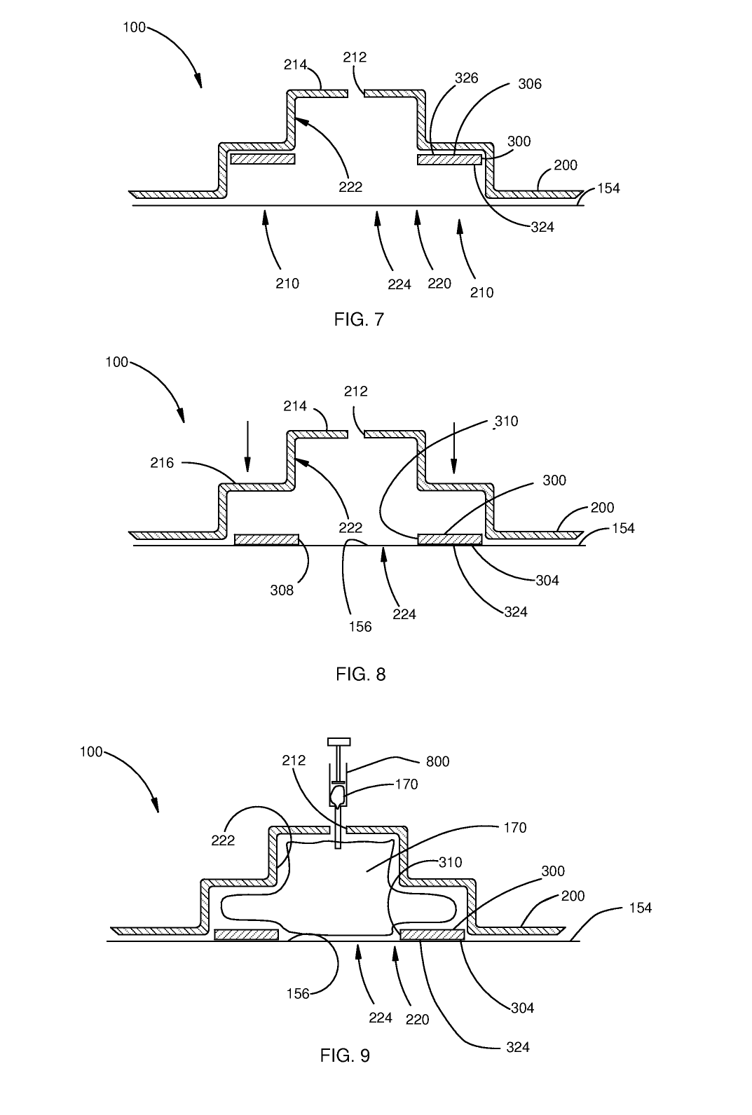

FIG. 3 is a bottom view of a mold cavity 224 and FIG. 4 is a cross-sectional view of the mold cavity 224 along cut-line 4-4 shown in FIG. 3, in accordance with an embodiment. FIGS. 7-11 are cross-sectional views of the mold cavity 224 along cut-line 7-7 shown in FIG. 1, in accordance with an embodiment, in various stages of using the system 100.

Each mold cavity 224 comprises an attachment negative impression 220 and an adjacent gasket cavity 210, each defined by a concavity of the template 200. The gasket cavity 210 defines a stepped concavity encircling a perimeter 223 of the attachment negative impression 220 and is operable to receive a gasket 300 therein, as shown, by way of example, in FIG. 7. The template 200 is operable to dispose the gasket 300 a distance away from the tooth surface 154 during placement of the template 200 onto the teeth 150, shown in FIG. 1, such that the gasket 300 does not come into contact with the tooth surface 154 as shown in FIG. 7.

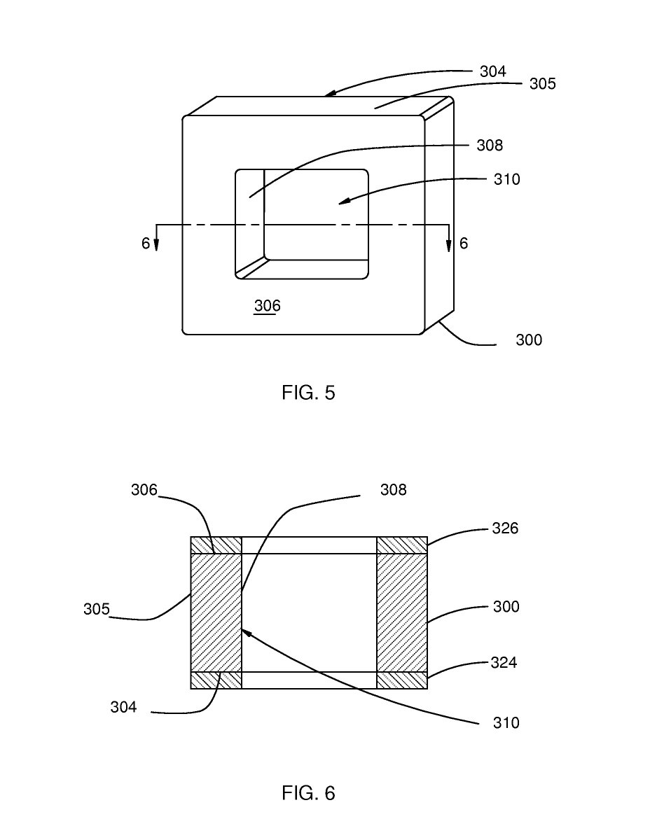

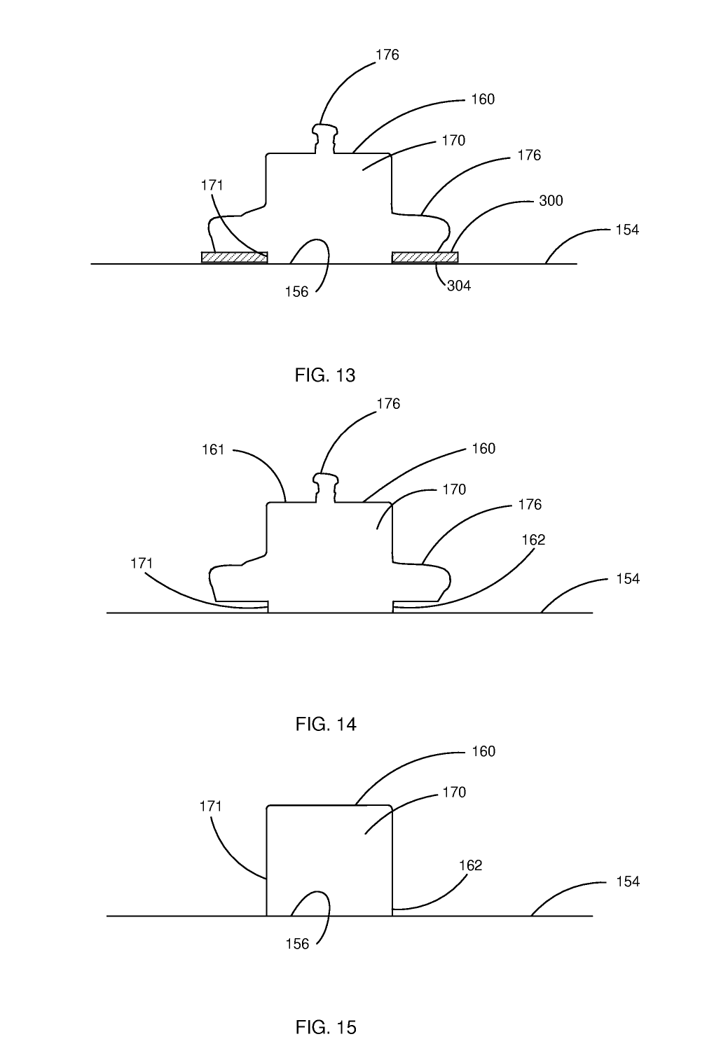

FIG. 5 is a perspective view of a gasket 300, in accordance with an embodiment. FIG. 6 is a cross-sectional view of an embodiment of a gasket 300 of the embodiment of FIG. 5 along cut-line 6-6. The gasket 300 comprises a gasket first surface 304 and a gasket second surface 306 opposite the gasket first surface 304. The gasket 300 defines a gasket aperture 310 extending from the gasket first surface 304 to the gasket second surface 306 therethrough. The gasket 300 defines a gasket outer wall 305 opposite the gasket aperture 310. The gasket aperture 310 defines gasket inner wall 308. As will be described further below, the gasket inner wall 308 defines at least a portion of the attachment device wall 171, as shown in FIG. 13. The distance between the gasket first surface 304 and the gasket second surface 306 generally defines the height of the gasket inner wall 308. In accordance with an embodiment, the distance between the gasket first surface 304 and a gasket second surface 306 is relatively small in comparison to the resulting height of the attachment device 160, therefore that portion of the attachment device wall 171 that is defined by the gasket inner wall 308 is relatively small in comparison to the resulting height of the attachment device 160 as shown in FIG. 15. In such case, the size and shape of the attachment device wall 171 is predominantly defined by the negative impression inner surface 222, as shown in FIG. 3, 4, 7-9.

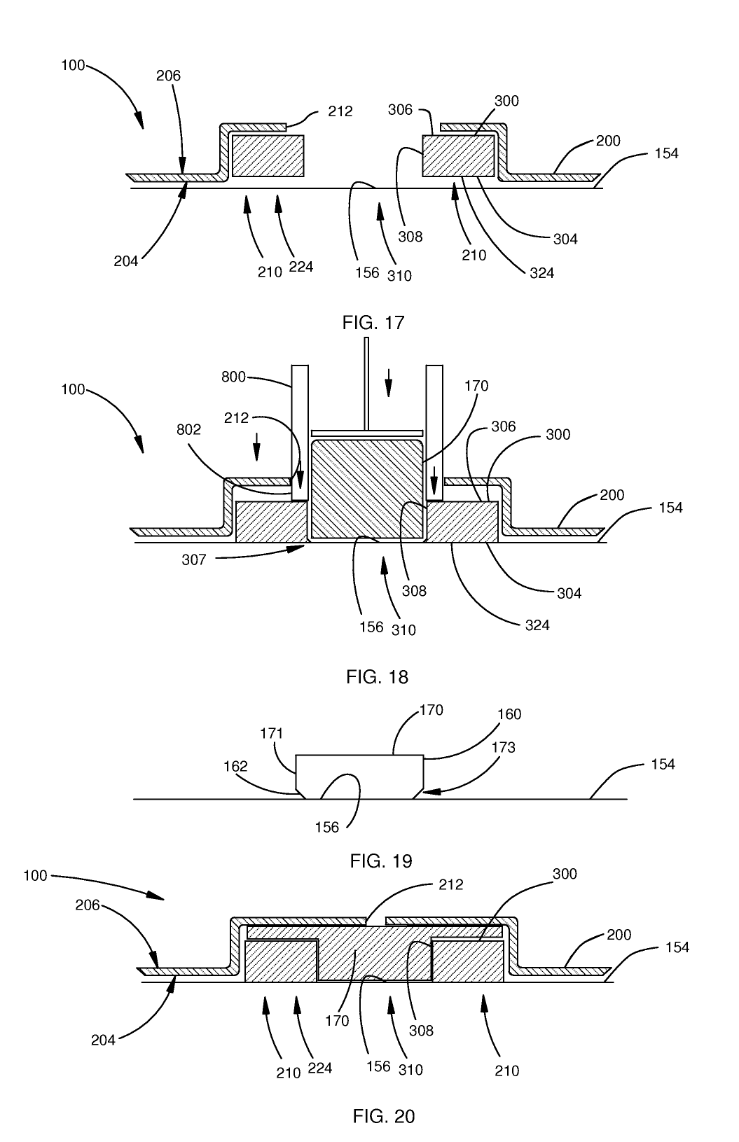

In accordance with another embodiment, the distance between the gasket first surface 304 and a gasket second surface 306 is substantially the same as the resulting height of the attachment device 160. Therefore, that portion of the attachment device wall 171 that is defined by the gasket inner wall 308 is substantially the same as that of the resulting height of the attachment device 160, as shown in FIGS. 17-20, and substantially as shown in FIG. 15 after removal of any flash 176 of curable material as shown in FIG. 14. In such embodiment, the size and shape of the attachment device wall 171 is predominantly defined by the gasket inner wall 308.

It is appreciated that the size and shape of the attachment device wall 171 as defined by the negative impression inner surface 222, shown in FIG. 4, or the gasket inner wall 308, shown in FIG. 17, is predetermined suitable for a particular purpose.

In accordance with an embodiment, the gasket 300 comprises an elastic material operable to be readily stretched and peeled from the tooth 150 and attachment device 160 after the curing of the curable material therein as shown in FIGS. 13-15. Being elastic means that the gasket 300 may be worked off from the attachment device 160 within it, or the gasket 300 may be cut or torn to be removed from the attachment device 160. In accordance with an embodiment, the gasket 300 is elastic or flexible such that it is operable to conform and couple to an irregular tooth surface 154.

It is understood that that gasket 300 may comprise any suitable material that can be readily removed from the tooth 150 and attachment device 160. Such materials may include, but not limited to, a material that may soften or dissolve when exposed to a solvent, such as paperboard or other fibrous material that may be softened with water, among many others. Such materials may include, but not limited to, a material that may be torn or provided with frangible portions to assist in tearing away, such as linear perforations that permit tearing along the perforations, among many others. Such materials may include, but not limited to, a material that may be ground away, broken apart, or melted away, such as cork and wax, among many others.

Referring again to FIG. 6, the gasket 300 further comprises a first adhesive layer 324 on the gasket first surface 304, in accordance with an embodiment. In accordance with another embodiment, the gasket 300 further comprises a second adhesive layer 326 on the gasket second surface 306, as shown in FIG. 6. The first adhesive layer 324 on the gasket first surface 304 is operable for removably coupling the gasket 300 to a tooth surface 154 as shown in FIG. 8. The gasket 300 is operable to be peeled off or otherwise removed from the tooth surface 154 after use without altering or damaging the tooth surface 154 or contour thereof.

The second adhesive layer 326 on the gasket second surface 306 is operable for removably coupling the gasket 300 to the gasket cavity 210 as shown in FIG. 7. The adhesive strength of the first adhesive layer 324 is relatively stronger than the adhesive strength of the second adhesive layer 326 such that the gasket 300 will adhere to the tooth surface 154 while decoupling from the gasket cavity 210 if the gasket 300 is caused to contact the tooth surface 154. As will be discussed further, the gasket 300 may be caused to contact the tooth surface 154 by, such as, but not limited to, depressing the template 200 at a location above the gasket 300 in the gasket cavity 210 toward the tooth surface 154 until the gasket 300 contacts the tooth surface 154 as shown in FIG. 8.

Referring again to FIGS. 5 and 6, in accordance with an embodiment, an outer wall adhesive layer (not shown) is disposed on the gasket outer wall 305 instead of or in addition to the second adhesive layer 326 on the gasket second surface 306, as shown in FIG. 6, the outer wall adhesive layer being operable for removably coupling the gasket 300 to the gasket cavity 210. The adhesive strength of the first adhesive layer 324 is relatively stronger than the outer wall adhesive layer (not shown) disposed on the gasket outer wall 305 such that the gasket 300 will adhere to a tooth surface 154 while decoupling from the gasket cavity 210 if the first adhesive layer 324 on the gasket first surface 304 is caused to contact the tooth surface 154.

It is appreciated that the gasket 300 may be retained in the gasket cavity 210 by means other than with adhesive. Such means may include, but not limited to, engagement elements, such as, but not limited to ridges 207 shown in FIG. 38, that engage the gasket 300 operable to frictionally engage and removably couple the gasket 300 to the gasket cavity 210. In accordance with another embodiment, the gasket 300 comprises an elastic material and is slightly oversized for the gasket cavity 210, wherein the gasket outer wall 305 affects a friction press-fit removable engagement with the gasket cavity 210. In accordance with another embodiment, the engagement elements (not shown) may be ridges or bumps on the gasket outer wall 305 that are slightly oversized for the gasket cavity 210, wherein the ridges or bumps affect a friction press-fit removable engagement with the gasket cavity 210. It is appreciated that there are many means for removably coupling the gasket 300 with the gasket cavity 210.

In use, a gasket 300 is placed within a gasket cavity 210 prior to placing the template 200 onto the teeth 150, as shown in FIGS. 1 and 7, in accordance with an embodiment. The template 200 is operable to dispose the gasket 300 a distance away from the tooth surface 154 during placement of the template 200 onto the teeth 150 such that the first adhesive layer 324 on the gasket 300 does not come into contact with the tooth surface 154, as shown in FIG. 7.

Once placed onto the teeth 150, the template 200 is operable to allow a user to advance the gasket 300 into contact with the tooth surface 154, as shown in FIG. 8. A number of methods are anticipated to affect pushing the gasket 300 into contact with the tooth surface 154. In accordance with an embodiment, the template 200 adjacent the mold cavity 224 is flexible such that the gasket 300 may be moved into contact with the tooth surface 154, as shown in FIG. 8, by pressing and deflecting a mold cavity top surface 214 towards the tooth surface 154. The gasket 300 is operable to be removably coupled to the tooth surface 154 and decoupled from the gasket cavity 210 with the gasket 300 coupling to the tooth surface 154 in a fluid-sealing engagement therewith.

The gasket aperture 310 of the gasket 300, as removably coupled to the tooth surface 154, defines a target tooth surface 156 as shown in FIGS. 8 and 9. As will be discussed below, the gasket 300 restricts curable material from contacting the tooth surface 154 that is outside of the target tooth surface 156; that is, the gasket 300 prevents the curable material from coming into contact with tooth surface 154 that is in contact with the gasket 300 and outside the target tooth surface 156. In other embodiments, the gasket 300 also restricts other substances that are used in the process of forming an attachment device, such as, but not limited to, cleaning, etching and bonding agents, from the tooth surface 154 that is outside the target tooth surface 156. As such, the gasket 300 defines the outer perimeter of the target tooth surface 156 that is to receive curable material with the gasket 300 contributing to the reduction of flash occurring outside of the target tooth surface 156, as will be discussed further below.

The predetermined location of each mold cavity 224 of the template 200 is determined by the prescribed location of a desired attachment device on a tooth surface. In accordance with an embodiment, one or more of the prescribed locations may be determined and prescribed, at least in part, by the dentist or template technician in accordance with a treatment plan. In accordance with another embodiment, the prescribed locations may be determined by a computer generated prescription plan.

As will be discussed below, each attachment negative impression is operable to receive curable material such that an attachment device may be formed of a desired size and shape and located at the prescribed location and orientation on a tooth surface. Discussion of the process for determining the prescribed orientation and location of the desired attachment device is provided below.

Referring again to FIGS. 3 and 4, each attachment negative impression 220 comprises a template aperture 212 extending from the template inner surface 204 to the template outer surface 206 therethrough. The template aperture 212 is operable to permit the deposition of curable material into the attachment negative impression 220 as will be described below. The template aperture 212 is located at a mold cavity top surface 214 of the attachment negative impression 220 such that the attachment negative impression 220 may be filled with curable material 170 as shown in FIG. 9. It is appreciated that the template aperture 212 may be formed in a process of manufacture of the template 200, such as, but not limited to, a molding process, stamping process, and a drilling process, and may be performed, such as, but not limited to, at the point of manufacture and by the practitioner prior to placement onto the teeth 150.

The template 200 may further comprise handling structures and surfaces (not shown) to assist in the placement and removal of the template 200 from the teeth 150, in accordance with another embodiment. Elements, such as, but not limited to, tabs and eyelets (not shown), may be incorporated into the template 200 to assist in placement on or pulling off of the template 200 from the teeth 150 by use of fingers or tools. The template 200 may incorporate frangible portions 217 to allow for the tearing or dividing of the template 200 into pieces to assist in removing the template 200 from the teeth 150, in accordance with another embodiment, as shown in FIG. 54. Frangible portions 217, such as, but not limited to, linear perforations or selective thinning (not shown) of the template 200, may be incorporated into the template 200 to assist in tearing or dividing apart of the template 200 from the teeth 150 after the attachment devices 160 have been formed.

The template 200 may, but not necessarily, fit over all teeth 150 present in the upper or lower jaw. In accordance with an embodiment, the template 200 is operable to fit over one or more teeth 150, one or more of which is to receive an attachment device 160. In accordance with an embodiment, the template 200 is operable to fit over one tooth 150 which is to receive an attachment device 160. The teeth 150 adjacent to those to receive an attachment device 160 may be used to provide a base or anchor region for holding the template 200 in place as it locates respective gasket cavities 210 over the desired locations of teeth 150 to receive an attachment device 160. In accordance with an embodiment, the template inner surface 204 sufficiently conforms to the contours of the teeth 150 such that the template 200 snaps into place and is removably coupled to the teeth 150. In another embodiment, the template 200 is manually held in place during placement onto the teeth 150 and cure of the curable material. In accordance with another embodiment, the gaskets 300, once coupled to the teeth 150, may also help to stabilize and retain the template 200 in the desired fully engaged position on the teeth 150.

The template 200 may comprise any suitable material and be fabricated using any suitable process. In accordance with an embodiment, the template 200 comprises a thin polymeric material. In accordance with an embodiment, the template 200 of FIG. 1 may be formed from a thin sheet of a suitable elastomeric polymer, such as Tru-Tain thermal forming dental material, Tru-Tain Plastics, Rochester, Minn. 55902, which may be formed over a replica of the teeth. In other embodiments, the template 200 may be formed using additive manufacturing technology, also known as rapid prototyping, in which the template 200 is produced from a base material directly from computer aided design software. It is appreciated that many fabrication processes may be suitable for fabricating the template 200 and not limited to the examples presented herein.

The template 200 may comprise a material at least translucent if not transparent to light-curing radiation wherein a light-curable material is used to form the attachment device. Further, a template 200 made of translucent or transparent material allows for visible inspection of the curable material 170, as shown in FIG. 9, during and after filling the negative impression 220 and gasket aperture 310. It is appreciated that portions of the template 200 may be made of a material that is not translucent or transparent to certain light frequencies, suitable for a particular purpose, such as, but not limited to, to prevent blue light cure of a blue light curable material but allows for visual inspection of the curable material within the negative impression 220 and gasket aperture 310.

It is understood that the curable material 170 may be any suitable material that may be placed in the negative impression 220 and cured forming the attachment device 160 that is coupled to the target tooth surface 156 as shown in FIG. 9. In accordance with embodiments, but not limited thereto, the curable material 170 may be of the type that comprises heat, chemical, or photochemical catalysts to affect a cure to a hardened state suitable for the particular purpose.

FIG. 9 is a cross-sectional view along cut-line 7-7 shown in FIG. 1 of an embodiment of a system 100 as disposed onto a tooth 150 with the addition of curable material 170, in accordance with an embodiment. Curable material 170 is shown substantially filling the negative impression 220 and gasket aperture 310 by use of a syringe 800, containing curable material 170, extending though the template aperture 212.

In accordance with an embodiment, the first adhesive layer 324 provides a substantially fluid-sealing engagement with the tooth surface 154 so as to resist the infiltration of curable material 170 between the tooth surface 154 and the gasket 300. In accordance with an embodiment, the first adhesive layer 324 resists the migration between the gasket first surface 304 and the tooth surface 154 of curable material 170 that is disposed within the negative impression 220 prior to curing the curable material 170 forming the attachment device 160 that is coupled to the target tooth surface 156.

In accordance with an embodiment, the gasket 300 comprises a material which is opaque to those light frequencies associated with curing curable material 170 of the type that is curable by exposure to light-curing radiation. The opaque gasket 300 is operable to shadow or block light-curing radiation from illuminating between the gasket 300 and the tooth surface 154 and therefore resists the curing of any curable material 170 that may unintentionally migrate between the gasket first surface 304 and the tooth surface 154. Any uncured curable material 170 left on the tooth surface 154 after removal of the gasket 300 may be removed relatively easily as compared with flash that is cured. Any flash 176 of curable material 170 that resided on the gasket 300 will be relatively easily removed from the resulting attachment device 160 as it will not be bonded to the tooth surface 154, as shown in FIG. 14. Any flash 176 of curable material 170 that resided in the template aperture 212, or the plate aperture 182 as described for the embodiment of FIG. 11, may be readily removed by, such as, but not limited to, mechanical grinding, and is in a non-critical plane of the attachment device so long as it is not proud of the prescribed surface profile of the attachment device 160.

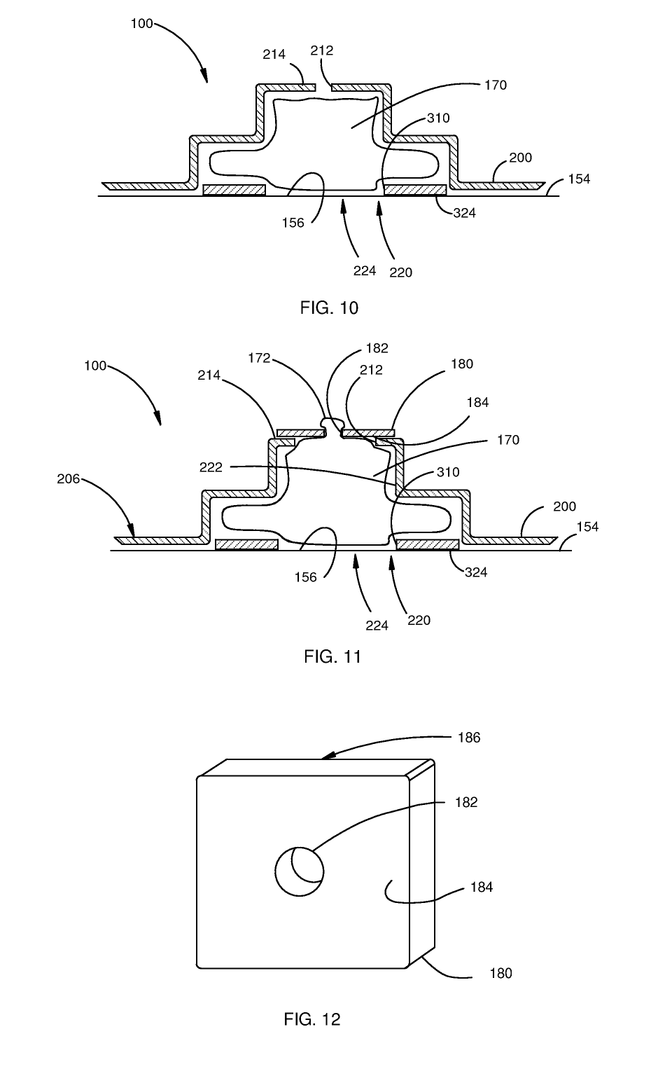

FIG. 10 is a cross-sectional view along cut-line 7-7 shown in FIG. 1 of an embodiment of a system 100 as disposed onto a tooth 150 with curable material 170 having been deposited within the negative impression 220 and gasket aperture 310. The curable material 170 is made to be substantially flush with the template aperture 212 prior to curing.

FIG. 11 is a cross-sectional view along cut-line 7-7 shown in FIG. 1 of an embodiment of a system 100 as disposed onto a tooth 150 with the addition of curable material 170 and a cover plate 180, in accordance with an embodiment. The curable material 170 is deposited into the negative impression 220 and gasket aperture 310 through a relatively large template aperture 212.

FIG. 12 is a perspective view of the cover plate 180 including a plate aperture 182 in accordance with an embodiment. The cover plate 180 comprises a plate inner surface 184 and a plate outer surface 186 opposite the plate inner surface 184. The plate aperture 182 extends from the plate inner surface 184 to the plate outer surface 186 therethrough. In accordance with an embodiment, the cover plate 180 is substantially flat. The cover plate 180 is operable to cover the template aperture 212 and overlay at least a portion of the mold cavity top surface 214 as shown in FIG. 11. Wherein a light-curable curable material is used to form an attachment device, the cover plate 180 may comprise a material that is at least translucent if not transparent to light-curing radiation.

The cover plate 180 is operable for allowing for the compression of the curable material 170 within the negative impression 220 and gasket aperture 310 to affect intimate contact between the curable material 170 and the target tooth surface 156, to conform the curable material 170 to the negative impression inner surface 222 of the negative impression 220, and to minimize voids within the curable material 170. The plate aperture 182 is operable for allowing excess curable material 172 to extrude from the negative impression 220 under pressure created as the cover plate 180 is pressed against the negative impression 220 and curable material 170, such as shown in FIG. 11.

It is appreciated that in another embodiment, the cover plate 180 may be provided without a plate aperture 182, wherein any excess curable material 172 may extrude around the edges of the cover plate 180 under pressure created as the cover plate 180 is pressed against the negative impression 220 and curable material 170. Uncured excess curable material 172 may simply be wiped off of the outer surface 206 of the template 200. Excess cured curable material 170 may be removed by, such as, but not limited to, mechanical grinding and trimming.

By way of example, but not limited thereto, a system 100 is described as suitable for a particular patient. Measurement data of a patient's teeth is collected. Measurement data may be collected by one of any suitable processes, such as, but not limited to, creating a physical impression of the patient's teeth and creating a virtual impression of the patient's teeth via a process such as, but not limited to, computer scanning. An impression, or a virtual, computer-generated “impression”, of the patient's teeth may be created. A computer model of the patient's teeth may be created based on the measurement data using processes known in the art, such as those described in Chishti et al., U.S. Pat. No. 5,975,893, incorporated herein by reference.

The design of the template 200 may be facilitated by computer-aided design methodologies known in the art, such as those provided in Chishti et al. in U.S. Pat. No. 5,975,893. A computer model of the patient's teeth and the desired result of the positions of the teeth is analyzed to determine whether the use of attachment devices would aid in the desired movement of the teeth from a first position to a second position. The use of attachment devices of particular geometries may provide movement of the teeth that is more efficient or along a different path than achievable based on relying entirely on force bearing natural tooth surfaces or contours of the teeth. The location and shape of attachment devices at specific locations of the teeth, as well as which specific shape of attachment device that is appropriate for the intended purpose, are determined using known methods as described.

A template 200 is created that is operable to engage and removably couple onto one or more of the teeth 150 in substantially the same manner as a positioning appliance as described in Chishti et al., U.S. Pat. No. 5,975,893. The template 200 is provided with negative impressions 220 and corresponding gasket cavities 210 corresponding to those locations that analysis had determined an attachment device 160 is to be provided on the teeth 150. Each negative impression 220 and corresponding gasket cavity 210 may define a unique shape so as to create an attachment device 160 having a prescribed unique shape, in accordance with an embodiment.

In accordance with embodiments of methods, each gasket cavity 210 is provided with a gasket 300 removably coupled to the gasket cavity 210, such as, but not limited to, with the second adhesive layer 326 coupling the gasket 300 to the gasket cavity 210 as previously described and shown in FIG. 7. The tooth surface 154 is prepared to receive the gasket 300 and the curable material 170. Wherein the first adhesive layer 324 on the gasket first surface 304 is operable to adhere to a clean tooth surface 154, the tooth surface 154 may be cleaned, such as to remove tarter and plaque, prior to placement of the template 200 onto the teeth 150.

Preparing the target tooth surface 156 to receive the curable material 170 may be provided in a plurality of separate steps, before, after, or both before and after placement of the template 200 onto the teeth 150. In accordance with an embodiment, the target tooth surface 156 may be prepared for bonding agents and curable material 170 prior to placement of the template 200 onto the teeth 150. In another embodiment, the target tooth surface 156 may be prepared for bonding agents and curable material 170 after removably coupling the gasket 300 to the tooth surface 154, with access to the target tooth surface 156 via the relatively large template aperture 212 in the embodiment of FIG. 11. Wherein preparing target tooth surface 156 for receiving the curable material 170 may involve relatively harsh chemicals, such as etching and bonding agents, preparing the target tooth surface 156 after placement of the gasket 300 isolates the preparation to only the target tooth surface 156, with the gasket 300 protecting the underlying tooth surface 154. Isolating the preparation to only the target tooth surface 156 not only helps to prevent tooth surface damage away from the target tooth surface 156, but also helps to prevent curable material 170 from adhering to tooth surface 154 adjacent to the target tooth surface 156.

The template 200 is placed over the teeth 150 as shown in FIGS. 1 and 7. Each gasket 300 is urged toward the tooth surface 154 and removably coupled with the tooth surface 154 and decoupled from the gasket cavity 210 as shown in FIG. 8, the first adhesive layer 324 removably coupling the gasket 300 to the tooth surface 154. The gasket aperture 310 of each gasket 300 defines the target tooth surface 156.

The gasket inner wall 308 and the negative impression inner surface 222 determine, in part, the resulting shape of the attachment device 160, as they form a mold for the attachment device 160. The shape of the negative impression inner surface 222 may be any suitable shape that is operable to be molded. By way of example, but not limited thereto, the negative impression inner surface 222 may have a square lateral cross-section that results in an attachment device 160 having a square lateral cross-section.

The shape of the attachment device 160 is predetermined based, in part, on the prescribed force desired for that specific location in order to transmit force generated by the dental positioning appliance to the teeth 150. The prescribed size and shape of the attachment devices 160 may vary in order to provide ideal function as prescribed during treatment plan development.

The attachment devices 160 may be coupled at specific locations throughout the dentition where appropriate and this may only be required at one or a plurality of locations. The attachment devices 160 may be coupled to any surface of the teeth 150, including lingual surfaces.

Curable material 170 is disposed within the negative impression 220 and the gasket aperture 310 and in contact with the target tooth surface 156, as shown in FIG. 9. As shown in the embodiment of FIG. 11A, cover plate 180 may be disposed over the template aperture 212 with any excess curable material 172 allowed to extrude from the plate inner surface 184 to the plate outer surface 186 through the plate aperture 182. Excess curable material 172 which has extruded from the plate aperture 182 or from around the edge of the cover plate 180 may be removed prior to curing the curable material 170. It is understood that a cover plate may not be required and that the curable material 170 may be conforming to the negative impression 220 and the gasket aperture 310 and leveled with the template aperture 212 with an instrument or finger, or the curable material 170 may be self leveling depending, in part, on the viscous properties of the curable material 170.

The curable material 170 is cured to a hardened state forming the attachment device 160 that is coupled to the target tooth surface 156, as shown in FIGS. 13-15. The template 200 is removed from the teeth 150 leaving an attachment device 160 and gasket 300, as shown in FIG. 13. The template 200 may be removed intact and reused for forming subsequent attachment devices 160 or may be divided into various pieces so as to be more easily removed from the teeth 150. Flash 176 of cured excess curable material 172 may be present in locations such as, but not limited to, above the gasket 300 where the gasket 300 had uncoupled from the gasket cavity 210 forming a gap to which the curable material 170 may migrate, and at the location of the template aperture 212 or plate aperture 182, shown in FIGS. 10 and 11, respectively.

The gasket 300 is removed from the tooth surface 154 and the attachment device 160 as shown in FIG. 14. Any flash 176 on the attachment device top surface 161 of the attachment device 160, such as that from within the plate aperture 182, or formed above the now removed gasket 300, is relatively easily removed, such as, but not limited to, by mechanical grinding and the like. Any uncured curable material that may be present around the attachment device base 162 from between the gasket first surface 304 and the tooth surface 154 may be removed by wiping or washing.

FIG. 15 is a side view of the attachment device 160 as coupled to the target tooth surface 156, in accordance with an embodiment. The resulting attachment device 160 presents a well-defined attachment device base 162 with little or no cured curable material 170, or flash 176, adjacent to the target tooth surface 156.

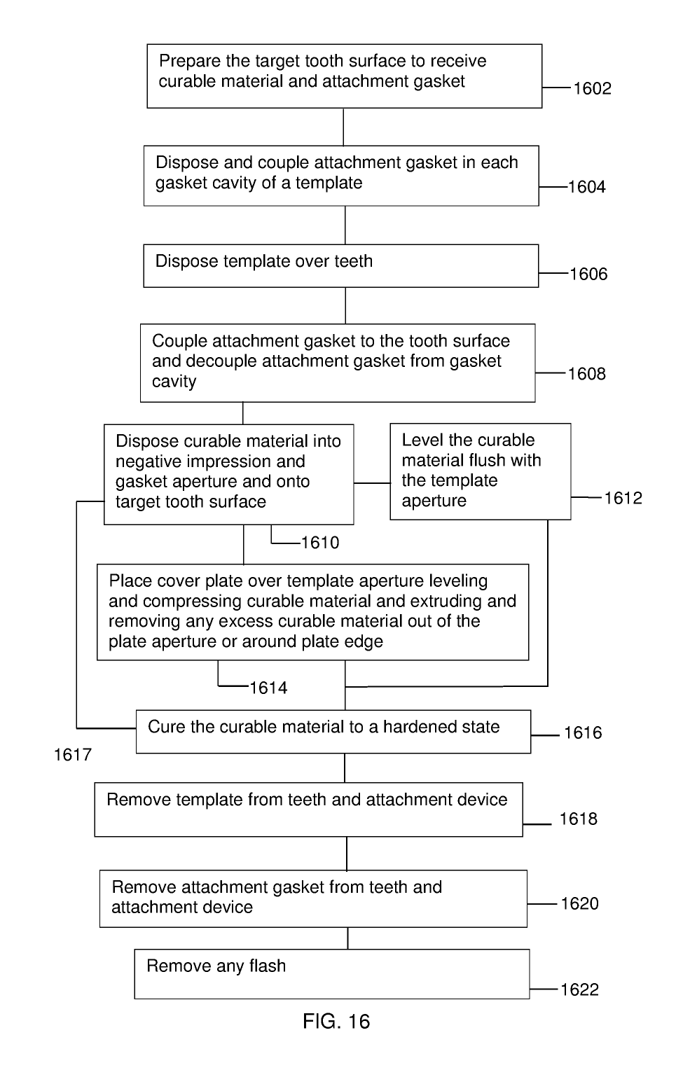

FIG. 16 is a flow chart of a method in accordance with an embodiment. The target tooth surface is suitably prepared to receive curable material and the gasket, such as, but not limited to, cleaned, etched, rinsed, dried, and treated with bonding agent 1602. A template comprising a prescribed number and placement of negative impressions and gasket cavities is provided. A gasket is disposed and removably coupled to each of the gasket cavities 1604. The template with the gaskets is placed over the teeth 1606. Each of the gaskets is removably coupled to the tooth surface and decoupled from the gasket cavity 1608. Curable material is disposed within the negative impression and gasket aperture and in contact with the target tooth surface 1610. In an embodiment, the curable material is made level with the template aperture 1612. In accordance with another embodiment, a cover plate is disposed over the template aperture compressing and extruding any excess curable material through a plate aperture or from a plate edge, with any excess curable material being removed from the cover plate 1614. The curable material is cured to a hardened state to form an attachment device that is coupled to the target tooth surface 1616. Additional attachment devices are formed either simultaneously or by repeating the process 1617. The template is removed from the teeth 1618. Each gasket is removed from the respective attachment device and the teeth 1620. Any flash is removed 1622.

The curable material may be cured to a hardened state by any process suitable for the particular material, including, but not limited to, self curing. By way of example, but not limited thereto, light-curable composite resin used for dental applications may be suitable for the particular purpose. Many curable materials are known in the art and it is appreciated that the materials are cured in the manner that the particular material is formulated to be cured.

FIG. 17 is a cross-sectional view of a mold cavity 224 and gasket 300 along cut line 7-7 of FIG. 1, in accordance with another embodiment of system 100. The gasket inner wall 308 of the gasket 300 substantially defines the shape and size of the desired attachment device. The mold cavity 224 comprises a gasket cavity 210 defining a concavity of the template inner surface 204. The gasket cavity 210 is operable to receive a gasket 300 therein. Each mold cavity 224 comprises a template aperture 212 extending from the template inner surface 204 to the template outer surface 206 therethrough. The template aperture 212 is operable to permit the deposition of curable material into the gasket aperture 310 as will be described below. The distance between the gasket first surface 304 and a gasket second surface 306 is substantially the same as the resulting height of the attachment device 160. Therefore, that portion of the attachment device wall 171 that is defined by the gasket inner wall 308 is substantially the same as that of the resulting height of the attachment device 160, as shown in FIG. 19. The template 200 is operable to dispose the gasket 300 a distance away from the tooth surface 154 during placement of the template 200 onto the teeth 150 such that the first adhesive layer 324 does not come into contact with the tooth surface 154. The gasket 300 is advanced toward and removably coupled to the tooth surface 154 in a subsequent step.

FIG. 18 is a cross-sectional view of the embodiment of FIG. 1 along cut line 7-7 wherein a syringe 800 filled with curable material 170 is provided to dispose curable material 170 into the gasket aperture 310. The syringe 800 comprises a syringe tip 802 that is adapted to pass through the template aperture 212. The size of the template aperture 212 is operable to expose at least a portion of the gasket second surface 306 to the syringe tip 802. In accordance with an embodiment, the gasket 300 and the syringe 800 cooperate such that the syringe tip 802 engages the gasket second surface 306, urgingly disengaging the gasket 300 from removable coupling with the gasket cavity 210 and urging the gasket first surface 304 and corresponding first adhesive layer 324 into contact with the tooth surface 154, such that the gasket 300 may be removably coupled to the tooth surface 154. In another embodiment the gasket 300 is advanced to the tooth surface 154 in substantially the same manner as previously described in discussion of the embodiment of FIG. 8.

In accordance with an embodiment, the gasket 300 comprises an elastic material such that a flange portion 307 is formed by compressive pressure of the syringe tip 802 upon the gasket 300. With the flange portion 307 being present, the curable material 170 is disposed within the gasket aperture 310. Wherein the curable material 170 has sufficient viscosity the curable material 170 will retain an impression of the flange portion 307 after the syringe tip 802 is removed from urging engagement with the gasket 300. The flange portion 307 provides an undercut 173 in the attachment device 160 at the attachment device base 162, as shown in FIG. 19. The attachment device 160 shown in FIG. 19 is in the state after removal of any flash 176. Any flash 176 may be removed by means discussed previously.

In other embodiments, the flange portion 307 may be a permanent feature of the gasket inner wall 308 shown in FIG. 18. It is understood that the shape of the gasket inner wall 308 may have a predetermined shape suitable for a particular purpose. By way of example, but not limited thereto, the gasket inner wall 308 may taper inward toward the tooth surface 154 such that dental bands and the like may be securely affixed to the resulting attachment device 160 having a wedge shape tapering toward the tooth surface 152.

FIG. 20 is a cross-sectional view of a mold cavity 224 and gasket 300 along cut line 7-7 of FIG. 1, in accordance with another embodiment of system 100. The gasket inner wall 308 of the gasket 300 substantially defines the shape and size of the resulting attachment device. The mold cavity 224 comprises a gasket cavity 210 defining a concavity of the template 200. The gasket cavity 210 is substantially the same size as the mold cavity 224 but for a small gap such that the gasket 300 stands off from the tooth surface 154 as previously described for the embodiment of FIGS. 7 and 8. The gasket cavity 210 is operable to receive a gasket 300 therein. Each mold cavity 224 comprises a template aperture 212 extending from the template inner surface 204 to the template outer surface 206 therethrough. The gasket 300 is advanced to the tooth surface 154 in substantially the same manner as previously described in discussion of the embodiment of FIG. 8, as shown in FIG. 20. The template aperture 212 is operable to permit the deposition of curable material 170 into the gasket aperture 310 in contact with the target tooth surface 156 substantially as described for the embodiment of FIG. 9.

Embodiments provided above are directed to forming and coupling attachment devices to dental surfaces suitable for cooperative engagement with positioning appliances. The cooperative engagement may, but not limited to, assist in the retention of the positioning appliance on the teeth and for the more efficient transmission of force(s) from the positioning appliance to the teeth. Embodiments herein allow for, among other things, the accurate placement of the attachment devices, the prevention of flash of the curable material on non-target tooth surfaces, the precise dimensionality of the attachment devices, the use of curable material having desirable viscosities or other material properties that are not dependent on the handling concerns of the template so as, for example, but not limited thereto, to prevent oozing of the curable material from the template during placement on the teeth, and allowing for the serial processing of forming multiple attachment devices, among other things.

Embodiments provided below are directed to coupling preformed attachment devices to dental surfaces suitable for cooperative engagement with positioning appliances. The cooperative engagement is substantially the same as for the attachment devices described above. Embodiments herein allow for, among other things, the accurate placement of the preformed attachment devices and the prevention of flash of bonding material on non-target tooth surfaces.

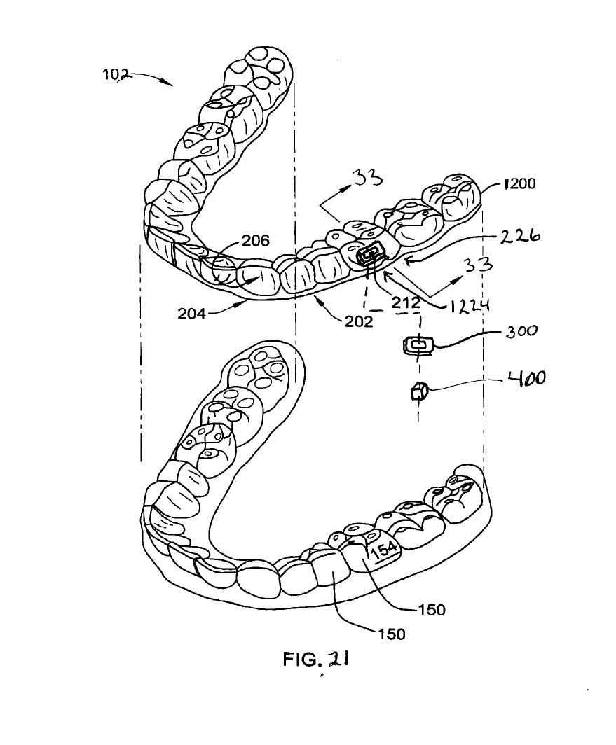

FIG. 21 is a perspective view of a system 102 for coupling preformed attachment devices 400 onto one or more teeth 150, in accordance with an embodiment. In FIG. 21, the system 102 comprises a template 1200, one or more preformed attachment devices 400, and one or more gaskets 300. The system 102 is operable for accurate placement and secure bonding of preformed attachment devices 400 onto the tooth surface 154 without having bonding material 174, used to bond the preformed attachment devices 400 onto the tooth surface 152, encroaching on unintended tooth surface 154 adjacent the preformed attachment device 400. The template 1200 is operable for accurate locating and positioning of the preformed attachment device 400 onto the tooth surface 154. The gasket 300 is operable to affect a substantially fluid-sealing engagement with the tooth surface and therefore mask unintended tooth surface 154 adjacent the preformed attachment device 400 from the bonding material 174.

The preformed attachment device 400 is operable to facilitate secure bonding to the tooth surface 154 via bonding material 174 so as to provide a desired cooperation with an oral appliance.

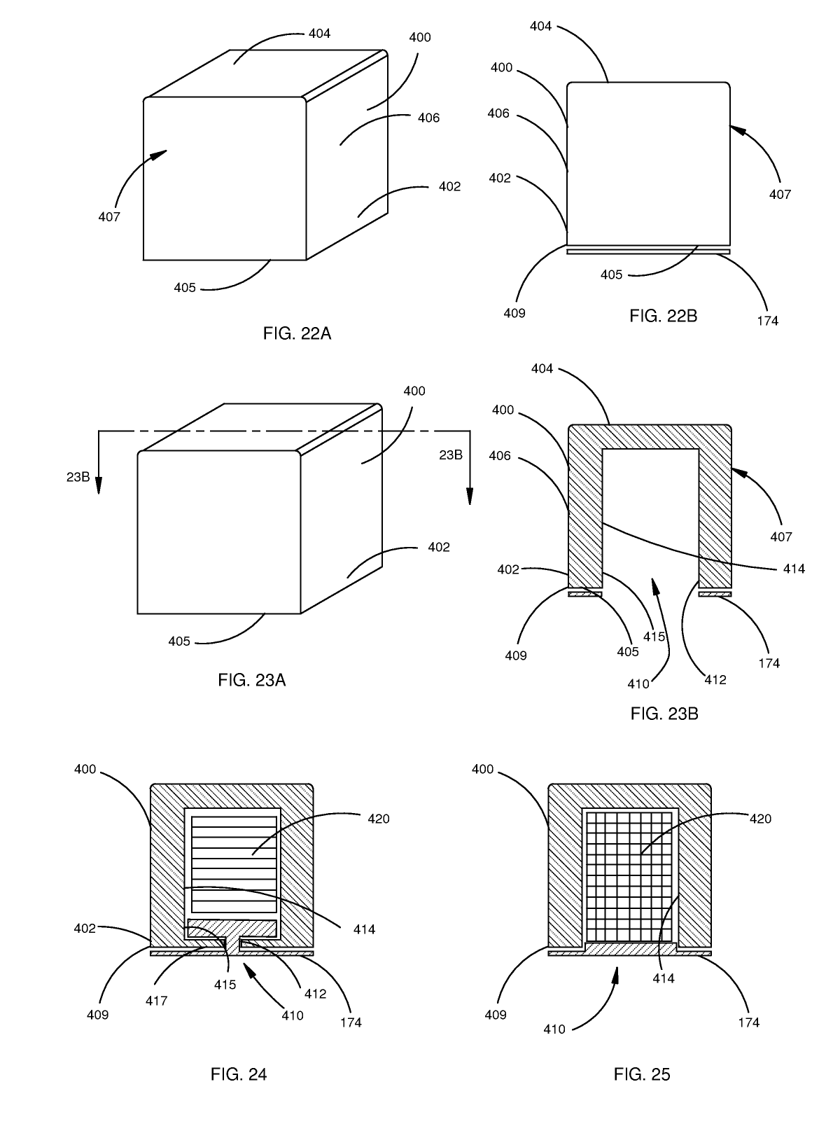

By way of example, but not limited thereto, for simplicity of explanation, FIGS. 22A and 22B are perspective and side views, respectively, of a preformed attachment device 400 defining a shape of a rounded cube. The preformed attachment device 400 defines a base 402 with a body 406 extending therefrom. The body 406 defines a body surface 407. The base 402 comprises a base surface 405 suitable for receiving bonding material 174 operable for coupling with the tooth surface 154 with the use of the bonding material 174 therebetween as shown in FIG. 2. It is appreciated that the body 406 may define any external shape suitable for the particular purpose so as to cooperate with dental appliances and other oral devices.

In the embodiment of FIG. 22B, the base surface 405 is substantially planar. Bonding material 174 that may be placed on the base surface 405 has the potential of extruding beyond a base perimeter 409 if the base surface 405 is urged against the tooth surface 154. To prevent the bonding material 174 from extruding beyond the base perimeter 409, in accordance with embodiments of the gasket 300 described below, any extruded bonding material 174 is directed to a preferred location for ease of removal or otherwise being of no consequence.

In accordance with an embodiment, excess bonding material 174 is accommodated within the preformed attachment device 400. It is appreciated that accommodation of excess bonding material 174 within the preformed attachment device 400 provides additional benefits, including, but not limited to, making it unnecessary to remove inadvertently-placed flash of cured bonding material 174 in a post-bonding operation.

FIGS. 23A and 23B are perspective and cross-sectional views, along cut line 23B-23B, respectively, of an embodiment of a preformed attachment device 400 defining an attachment cavity 410 in communication with the base 402 via an attachment aperture 412. The attachment cavity 410 defines an attachment wall 414 having a cavity surface 415. In accordance with an embodiment of a method of using the system 102, the attachment cavity 410 provides a location in which to receive and accommodate any excess bonding material 174 that may extrude therein from adjacent the base 402. In cooperation with the gasket 300, the excess bonding material 174 will extrude into the attachment cavity 410 and not beyond the base perimeter 409 opposite the attachment aperture 412, as will be discussed below.

In accordance with an embodiment of a method of using the system 102, bonding material 174 is disposed within the attachment cavity 410 and not necessarily on the base surface 405, with boding occurring between the tooth surface 154 and the cavity surface 415 via the bonding material 174, as will be discussed further below.

FIG. 24 is a cross-sectional view, along cut line 23B-23B of FIG. 23A, of another embodiment of a preformed attachment device 400 defining an attachment cavity 410 in communication with the base 402 via an attachment aperture 412. The attachment aperture 412 is defined by an internal flange 417 that extends from the attachment wall 414 at the base 402. The internal flange 417 defines the attachment aperture 412. The internal flange 417 is operable to provide additional surface area of the cavity surface 415 and to provide additional structure for which to mechanically bond the preformed attachment device 400 with the cured bonding material 174 to the tooth surface 154 by entrapping the internal flange 417 with the bonding material 174.

It is anticipated that air may be entrapped within the attachment cavity 410 when disposed with bonding material 174 preventing migration of the excess bonding material 174 into the attachment cavity 410, and therefore the excess bonding material 174 may be caused to extrude past the base perimeter 409 opposite the attachment aperture 412 rather than be contained within the attachment cavity 410. Also, if the attachment cavity 410 is overfilled with bonding material 174, the excess bonding material 174 may be caused to extrude past the base perimeter 409 rather than be contained within the attachment cavity 410. Embodiments of pressure relief elements are provided below that are operable to address air entrapment and other issues.

FIG. 25 is a cross-sectional view, along cut line 23B-23B of FIG. 23A, of a preformed attachment device 400 further comprising a pressure relief element 420 disposed within the attachment cavity 410, in accordance with an embodiment. The pressure relief element 420 is operable such that the preferred movement of excess bonding material 174 is toward the attachment cavity 410 and not out toward the base perimeter 409. The pressure relief element 420 comprises a material operable to provide a path for which excess bonding material 174 may extrude. The pressure relief element 420 may be any suitable material suitable for the purpose, including, but not limited to, a compressible material, such as, but not limited to, foam, a porous material, such as, but not limited to, a fibrous mesh, or a material with compressibility and porosity, such as, but not limited to, polyester fiber and cotton wadding.

FIG. 26A is a cross-sectional view, along cut line 23B-23B of FIG. 23A, of a preformed attachment device 400 wherein the pressure relief element 420 comprises a compressible material, shown with bonding material 174 disposed thereon, in accordance with an embodiment. FIG. 26B is a cross-sectional view, along cut line 23B-23B of FIG. 23A, of the embodiment of FIG. 26A wherein the pressure relief element 420 has been compressed by the extrusion of excess bonding material 174 into the attachment cavity 410 when the base surface 405 is brought into contact with the tooth surface 154, in accordance with an embodiment.

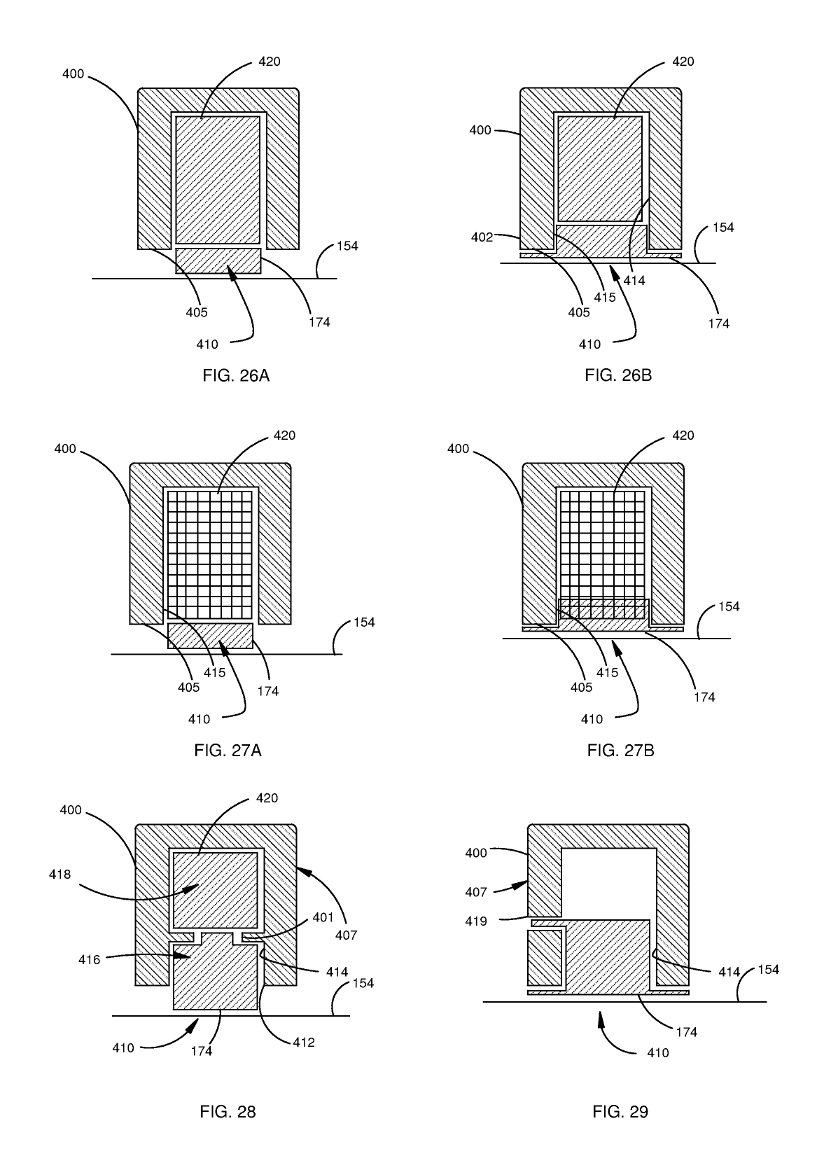

FIG. 27A is a cross-sectional view, along cut line 23B-23B of FIG. 23A, of a preformed attachment device 400 wherein the pressure relief element 420 comprises a porous material, shown with bonding material 174 disposed thereon, in accordance with an embodiment. FIG. 27B is a cross-sectional view, along cut line 23B-23B of FIG. 23A, of the embodiment of FIG. 27A wherein the pressure relief element 420 has allowed the excess bonding material 174 to extrude therein when the base surface 405 comes into contact with the tooth surface 154, in accordance with an embodiment.

In accordance with an embodiment, the pressure relief element 420 fills a substantial portion of the attachment cavity 410 such that a reduced amount of bonding material 174 is necessary to affect coupling between the preformed attachment device 400 and the tooth surface 154, and to provide a relatively large pressure relief characteristic, that is, to allow excess bonding material 174 to migrate into the attachment cavity 410, as compared to if the pressure relief element 420 filled a smaller volume of the attachment cavity 410. A relatively small amount of bonding material 174 may be effective to affect a suitable bond with the tooth surface 154 and the base surface 405 of the preformed attachment device 400 and/or the cavity surface 415, shown in FIGS. 26B and 27B.

FIG. 28 is a cross-sectional view, along cut line 23B-23B of FIG. 23A, of a preformed attachment device 400 wherein the attachment cavity 410 is divided into a first cavity 416 and a second cavity 418, the second cavity 418 in communication with the first cavity 416 via a cavity aperture 401, in accordance with an embodiment. The first cavity 416 is in communication with the attachment aperture 412. The first cavity 416 or the second cavity 418, or both, may have a pressure relief element 420 disposed therein, as described above. Wherein the second cavity 418 contains a pressure relief element 420, the cavity aperture 401 may be dimensionally predetermined to allow placement and retention of the pressure relief element 420 therein. In accordance with an embodiment, the preferential extrusion path of excess bonding material 174 is through the cavity aperture 401 and into the second cavity 418.

FIG. 29 is a cross-sectional view, along cut line 23B-23B of FIG. 23A, of a preformed attachment device 400 further comprising a pressure relief aperture 419 defined by the attachment wall 414, in accordance with an embodiment. The pressure relief aperture 419 is operable to permit air or excess bonding material 174 to pass out of the attachment cavity 410 and exit the preformed attachment device 400. It is anticipated that upon cure of the bonding material 174 a clean up procedure will be likely required to either fill in the pressure relief aperture 419 if it is underfilled, or remove excess bonding material 174 if it protrudes from the pressure relief aperture 419 such that the bonding material 174 at the pressure relief aperture 419 is made substantially flush with the attachment body surface 407.

The shape of the preformed attachment device 400 may be predetermined based, in part, on the desired force generated to the teeth by the engagement of a dental positioning appliance and the preformed attachment device 400. The prescribed size and shape of the preformed attachment device 400 may vary in order to provide ideal function as prescribed during treatment plan development.

The preformed attachment device 400 may be coupled at specific locations throughout the dentition where appropriate and this may only be required at one or a plurality of locations. The preformed attachment device 400 may be coupled to any suitable surface of the teeth 150, including lingual surfaces.

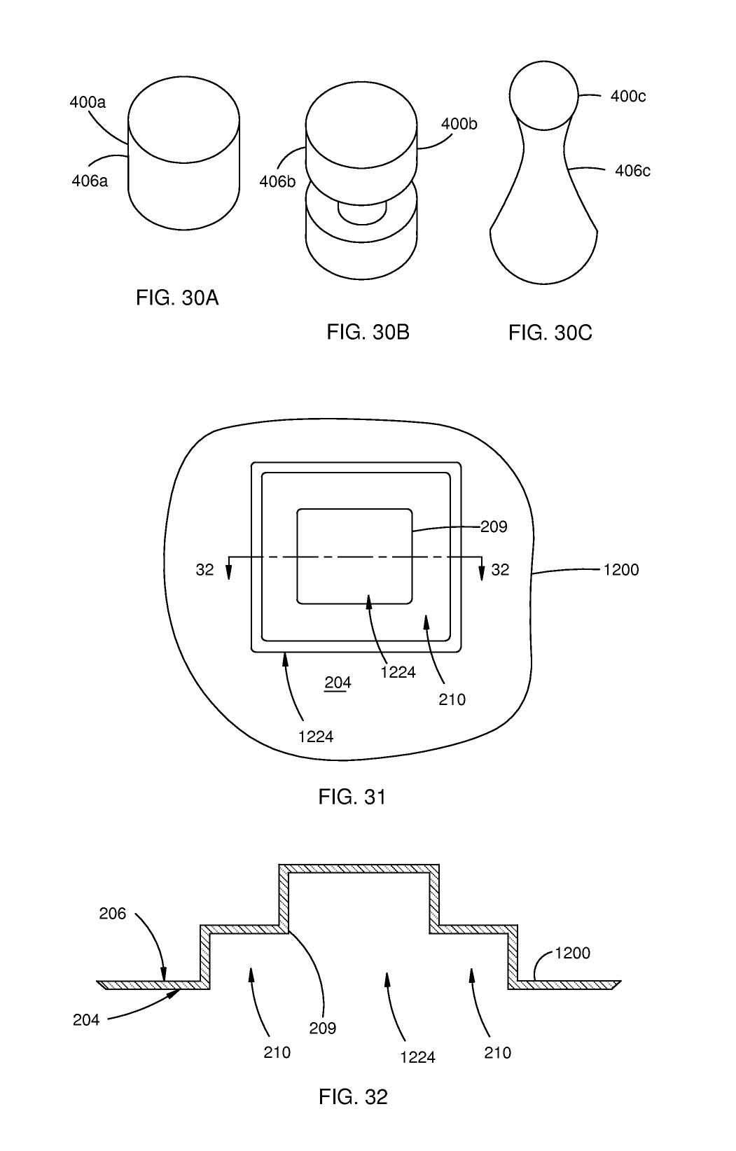

FIGS. 30A-C are various embodiments of preformed attachment devices 400a, 400b, 400c, respectively. It is understood that the body 406 of the preformed attachment device 400 may define any external shape suitable for the particular purpose. By way of example, but not limited thereto, a preformed attachment device 400 may define a rounded cube as shown in FIG. 22A, a cylinder as shown as preformed attachment device 400a in FIG. 30A, a notched cylinder as shown as preformed attachment device 400b, and that having a complex shape as shown as preformed attachment device 400c in FIG. 30C. The external shape of the body 406, 406a-c, of the preformed attachment device 400, 400a-c is predetermined to cooperate with dental appliances and devices as discussed previously. In another embodiment, the preformed attachment device 400 may be a dental bracket as is well known in the art.

Referring again to FIG. 23B by way of example, the base surface 405 of the base 402 of the preformed attachment device 400 defines a uniform surface across the entire base surface 405. In other embodiments, the surface 405 defines a surface texture, such as, but not limited to, ridges, grooves, or pits, that are operable to assist in the adherence of the bonding material 174 to the base surface 405.

It is understood that that preformed attachment device 400 may comprise any material suitable for the particular purpose. Preformed attachment devices 400 may comprise a metal, polymer, composite, ceramic or other materials that are suitable for use as dental appliances. In use, a preformed attachment device 400 is required to be able to withstand years in an oral environment, strong enough to resist breaking under loading from the teeth and any dental appliance that may be coupled thereto and able to transmit force to the tooth by the attachment of a dental appliance.

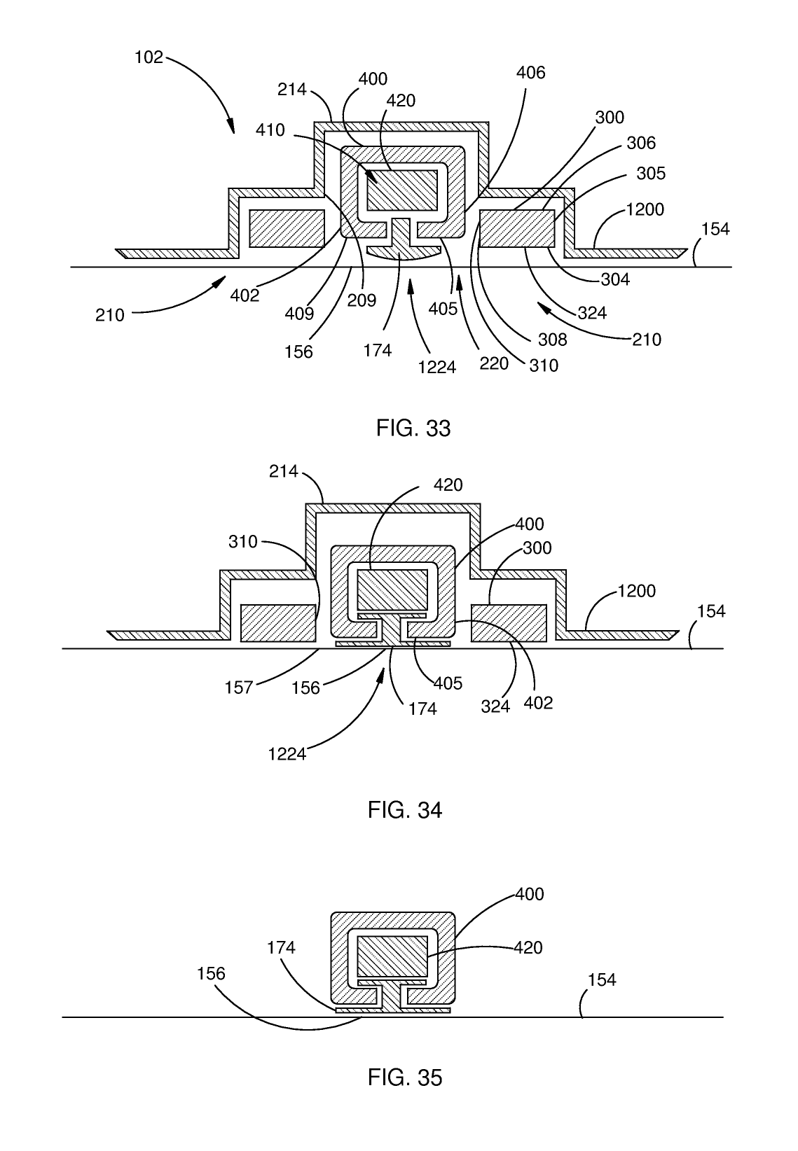

FIG. 31 is a bottom view of template 1200 of the embodiment of FIG. 21. FIG. 32 is a cross-sectional view of the template 1200 at cut line 32-32 of the embodiment of FIG. 31. FIG. 33 is a cross-sectional view of the template 1200 at cut line 32-32 of the embodiment of FIG. 31. The template 1200 of the embodiment of FIG. 21 is substantially the same as the template 200 of the embodiment of FIG. 1. In contrast with the system 100 of FIG. 1 where the template 200 defines one or more mold cavities 224 for receiving curable material so as to form an attachment device, template 1200 of system 102 of FIG. 21 defines one or more attachment receiving elements 226 being operable to receive one or the one or more preformed attachment devices 400 therein. In the embodiment of FIG. 21, the attachment receiving elements 226 comprise attachment receiving cavities 1224 being operable for receiving a preformed attachment device 400 therein. The template 1200 comprises a shell having a cavity 202 with a shape operable to receive one or more teeth 150. The template 1200 defines a template inner surface 204 and a template outer surface 206 opposite the template inner surface 204. The template 1200 is operable to removably engage the teeth 150. The template 1200 comprises an attachment receiving cavity 1224 operable to receive a preformed attachment device 400 therein and a corresponding gasket cavity 210 operable to receive a gasket 300 therein at one or more predetermined locations.

Surrounding each attachment receiving cavity 1224 is a corresponding gasket cavity 210, each defining a concavity of the template 1200. The gasket cavity 210 defines a stepped concavity defining an attachment receiving cavity perimeter 209 of the attachment receiving cavity 1224. The gasket cavity 210 is operable to receive a gasket 300 therein, as shown, by way of example, in FIG. 33. The attachment receiving cavity 1224 is a concavity operable to receive a preformed attachment device 400 therein, as shown in FIG. 33.

The predetermined location of each attachment receiving cavity 1224 is determined by the prescribed location of a desired preformed attachment device 400 on a tooth surface 154 as described in previous embodiments. Discussion of the process for determining the prescribed orientation and location of the desired attachment device 400 is provided above with regard to the attachment device 160 of the embodiment of FIG. 2, and not repeated here. In accordance with an embodiment, each attachment receiving cavity 1220 is operable to receive a preformed attachment device 400 of a desired size and shape and located at the prescribed location and orientation on a tooth surface 154.

Each attachment receiving cavity 1224 may define a unique shape so as to restrict the use to a particular preformed attachment device 400 having a corresponding prescribed unique shape in that particular attachment receiving cavity 1224, in accordance with an embodiment.

FIGS. 33-35 are cross-sectional views of the template 1200 at an attachment receiving cavity 1224, gasket 300, and preformed attachment device 400, along cut-line 33-33 shown in FIG. 21, in accordance with an embodiment, in various stages of using the system 102. The preformed attachment device 400 is shown by way of example as the embodiment of FIG. 24.

The gasket 300 is substantially the same as the gasket 300 of FIG. 5. As will be discussed below, the gasket 300 is operable to encircle the base perimeter 409 of the base 402 of the preformed attachment device 400 so as to limit or prevent the deposition of bonding material 174 on tooth surface 154 upon which the gasket 300 is coupled. Referring to FIGS. 5 and 33, the gasket 300 comprises a gasket first surface 304 and a gasket second surface 306 opposite the gasket first surface 304. The gasket 300 defines a gasket aperture 310 extending from the gasket first surface 304 to the gasket second surface 306 therethrough. The gasket 300 defines a gasket outer wall 305 opposite the gasket aperture 310. The gasket aperture 310 defines a gasket inner wall 308.

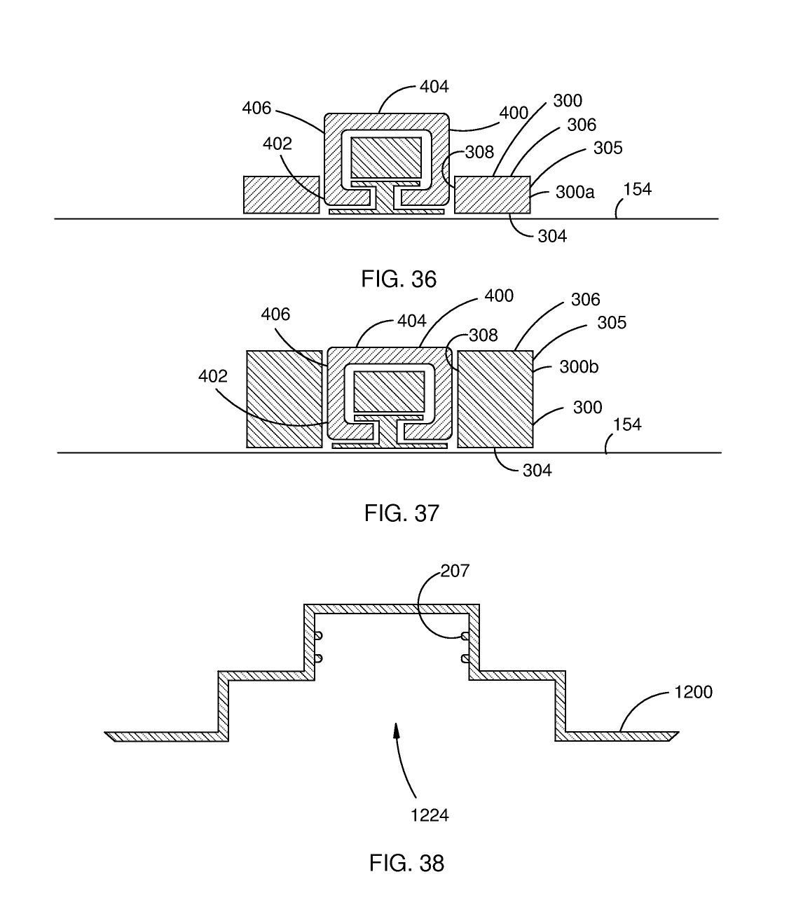

As will be described further below, in accordance with an embodiment, the gasket inner wall 308 is operable to engage at least a portion of the body 406 of the preformed attachment device 400 about the base perimeter 409, as shown in FIGS. 33 and 36, which is a cross-sectional view of the gasket 300 and preformed attachment device 400, along cut-line 32-32 shown in FIG. 31, in accordance with an embodiment. The distance between the gasket first surface 304 and the gasket second surface 306 generally defines the height of the gasket inner wall 308. In accordance with an embodiment, the distance between the gasket first surface 304 and a gasket second surface 306 of gasket 300a is relatively small in comparison to the height of the preformed attachment device 400.

In accordance with another embodiment, the distance between the gasket first surface 304 and a gasket second surface 306 of gasket 300b is substantially the same as the height of the preformed attachment device 400, the height being defined as the distance from the base 402 to the top 404, as shown in FIG. 37 which is a cross-sectional view of the gasket 300b and preformed attachment device 400 along cut-line 33-33 shown in FIG. 21. Therefore, that portion of the preformed attachment device 400 that is operable to be engage by the gasket inner wall 308 is substantially the entire body 406 of the preformed attachment device 400. In accordance with an embodiment, the gasket 300b is operable to hold the preformed attachment device 400 within the attachment receiving cavity 1224.

As previously discussed, in accordance with an embodiment, the gasket 300 comprises an elastic material operable to be readily stretched and peeled from the tooth 150 and the preformed attachment device 400 after the curing of the bonding material 174. Also as previously discussed, it is understood that that gasket 300 may comprise any suitable material that can be readily removed from the tooth 150 and the preformed attachment device 400.

Referring again to FIGS. 6 and 33, the gasket 300 further comprises a first adhesive layer 324 on a gasket first surface 304, in accordance with an embodiment. The first adhesive layer 324 on the gasket first surface 304 is operable for removably coupling the gasket 300 to the tooth surface 154. The gasket 300 is operable to be peeled off or otherwise removed from the tooth surface 154 after use without altering or damaging the tooth surface 154 or contour thereof.

As previously discussed, the gasket 300 may be retained within the gasket cavity 210 by various means, such as, but not limited to adhesive and frictional engagement, such that the gasket 300 will adhere to the tooth surface 154 while decoupling from the gasket cavity 210 if the first adhesive layer 324 on the gasket first surface 304 is caused to contact the tooth surface 154. It is appreciated that there are many means for removably coupling the gasket 300 with the gasket cavity 210.

The preformed attachment device 400 may be retained in the attachment receiving cavity 1224 by any suitable means. In accordance with an embodiment, the preformed attachment device 400 and attachment receiving cavity 1224 are operable for cooperative frictional engagement. By way of example, a suitable frictional engagement that retains the preformed attachment device 400 within the attachment receiving cavity 1224 but is readily expelled from the attachment receiving cavity 1224 as discussed below, may be affected by the inclusion of ridges 207, as shown in FIG. 38, which is a cross-sectional view of the attachment receiving cavity 1224, along cut-line 33-33 shown in FIG. 21, in accordance with an embodiment. Other means for retaining the preformed attachment device 400 within the attachment receiving cavity 1224 include, but are not limited to, adhesive, snap-fit, and selective frangible portions of the template 1200 allowing the template 1200 to break away from the preformed attachment device 400, and coupling with the gasket 300 using, for example, but not limited to adhesive or frictional engagement.

In accordance with another embodiment, the gasket 300 comprises an elastic material and the gasket aperture 310 is operable to frictionally engage the preformed attachment device 400 about the base 402. In accordance with another embodiment, an adhesive layer (not shown) is disposed on the gasket inner wall 308 operable to removably engage the preformed attachment device 400 about at least a portion of the body 406, such as about the base 402.

It is appreciated that the preformed attachment device 400 may be retained in the attachment receiving cavity 1224 by means other than with friction or adhesive. It is appreciated that there are many means for removably coupling the preformed attachment device 400 with the attachment receiving cavity 1224.

As shown in FIG. 33, the gasket first surface 304 of the gasket 300 extends beyond a plane defined by the base surface 405 of the preformed attachment device 400 in the direction toward the tooth surface 154. This is operable such that the gasket first surface 304 comes into contact with the tooth surface 154 before the bonding material 174 on the base surface 405 has a chance to extrude beyond the base perimeter 409 when the bonding material 174 comes into contact with the target tooth surface 156. As such, the gasket 300 forms a fluid seal with the tooth surface 154 prior to any extrusion of bonding material 174 toward the gasket 300, such that the gasket 300 prevents the bonding material 174 from migrating under the gasket 300 and thus prevents flash.

The bonding material 174 is disposed into the attachment cavity 410 such that the bonding material 174 extends beyond a plane defined by the base surface 405 of the preformed attachment device 400 in the direction toward the tooth surface 154 such that it may come into intimate contact with the target tooth surface 156 when the preformed attachment device 400 is advanced toward the tooth surface 154.

FIGS. 33-35 are cross-sectional views of the template 1200 at the attachment receiving cavity 1224, gasket 300, and the preformed attachment device 400, along cut-line 33-33 shown in FIG. 21, in accordance with an embodiment, in various stages of using the system 102. The preformed attachment device 400 is shown by way of example as the embodiment of FIG. 24, including the pressure relief element 420. In preparation for use of the system 102, a gasket 300 and a preformed attachment device 400 are placed within a gasket cavity 210 and attachment receiving cavity 1224, respectively, prior to placing the template 1200 onto the teeth 150, as shown in FIG. 21, in accordance with an embodiment. The bonding material 174 is disposed on the base surface 405 and/or in the attachment cavity 410 and/or onto the pressure relief element 420 prior to placing the template 1200 onto the teeth 150.

The template 1200 is operable to dispose the gasket 300 and the base surface 405 of the preformed attachment device 400 a distance away from the tooth surface 154 during placement of the template 1200 onto the teeth 150 such that the first adhesive layer 324 and the bonding material 174 do not come into contact with the tooth surface 154. The template comprises means for advancing each gasket into engagement with the tooth surface to affect a substantially fluid-sealing engagement therebetween with the gasket aperture defining target tooth surface. Once placed onto the teeth 150, the template 1200 is operable to allow a user to advance the gasket 300 and the base surface 405 of the preformed attachment device 400 into contact with the tooth surface 154, as shown in FIG. 34. A number of methods are anticipated to affect advancing the gasket 300 and preformed attachment device 400 into contact with the tooth surface 154. In accordance with an embodiment, the template 1200 adjacent the attachment receiving cavity 1224 and the gasket cavity 210 is flexible and operable such that the preformed attachment device 400 and the gasket 300 may be moved into contact with the tooth surface 154, as shown in FIG. 34, by urging the attachment receiving cavity top surface 214 towards the tooth surface 154. The gasket 300 and preformed attachment device 400 are operable to be removably coupled to the tooth surface 154 and decoupled from the gasket cavity 210 and the attachment receiving cavity 1224, respectively, once contact and bonding is affected.

The gasket 300, as removably coupled to the tooth surface 154, defines a target tooth surface 156 by the gasket aperture 310, as shown in FIG. 34. As will be discussed below, the gasket 300 restricts bonding material from contacting the tooth surface 154 that is outside of the target tooth surface 156; that is, the gasket 300 prevents the bonding material from coming into contact with tooth surface 154 that is in contact with the gasket 300 and outside the target tooth surface 156. As such, the gasket 300 defines a target tooth surface outer perimeter 157 of the target tooth surface 156 that may receive bonding material with the gasket 300 contributing to the reduction of flash occurring outside of the target tooth surface 156.

It is appreciated that any suitable bonding material 174 may be used for the particular purpose of bonding the preformed attachment device 400 to the tooth surface 154. FIG. 33 is a cross-sectional view along cut-line 33-33 shown in FIG. 21 of an embodiment of the system 102 prior to being disposed onto a tooth 150 with the addition of bonding material 174, in accordance with an embodiment. Bonding material 174 is shown disposed in the attachment cavity 410 and on the base 402, which may be dispensed using a syringe containing bonding material 174.

Such bonding material 174, includes, but is not limited to, self-curing and light-curing bonding material 174 commonly used in the dental arts. Blue light-curing bonding material 174 is well known in the dental arts. The bonding material may possess a sufficient viscosity so as to not drip and run during placement of the template 1200 onto the teeth 150.

With regard to a light-curing material, in order to cure the bonding material 174, exposure to a certain frequency of light radiation is required. Wherein a light-curing bonding material 174 is used to bond the preformed attachment device 400 to the tooth surface 154, the template 1200 and the preformed attachment device 400 may comprise a material at least translucent, if not transparent, to light-curing radiation. Further, a template 1200 made of translucent or transparent material allows for visible inspection of the gasket 300 and the preformed attachment device 400 during positioning and bonding.

The bonding material 174 may be cured to a hardened state by any process suitable for the particular material, including, but not limited to, self curing. By way of example, but not limited thereto, light-curable composite resin used for dental applications may be suitable for the particular purpose. Many curable bonding materials are known in the art and it is appreciated that the materials are cured in the manner that the particular material is formulated to be cured.

In accordance with an embodiment, the base surface 405 of the preformed attachment device 400 may be held against the tooth surface 154 by the practitioner as the bonding material 174 is cured to a hardened state coupling the preformed attachment device 400 to the target tooth surface 156. After the bonding material 174 is cured, the template 1200 and the gasket 300 may be removed from the teeth 150 and from the preformed attachment device 400, as shown in FIG. 35. The template 1200 may be removed intact and reused for positioning subsequent attachment devices 160 or may be divided into various pieces so as to be more easily removed from the teeth 150.

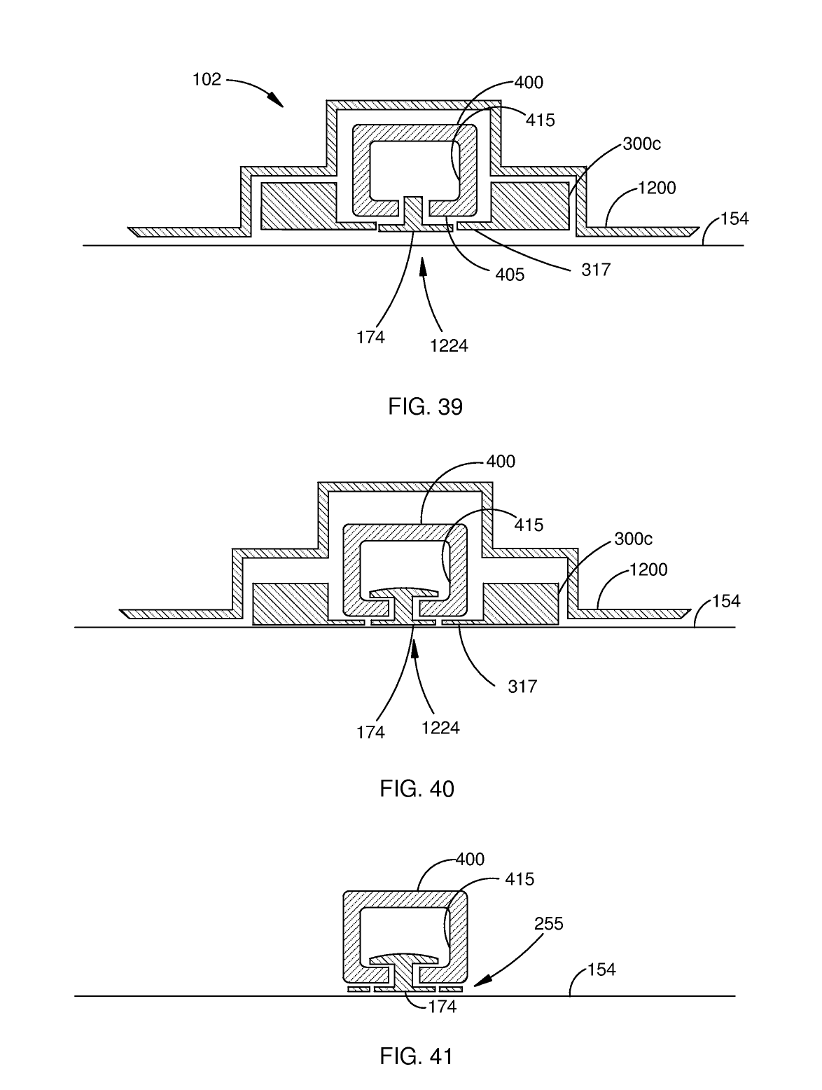

FIGS. 39-41 are cross-sectional views of the template 1200 at the attachment receiving cavity 1224, gasket 300c, and preformed attachment device 400, along cut-line 33-33 shown in FIG. 21, in accordance with another embodiment, in various stages of using the system 102. The preformed attachment device 400 is shown by way of example as the embodiment of FIG. 24. The gasket 300c is substantially the same as the gasket 300 of FIG. 33, but in this embodiment, the gasket 300c further comprises a gasket flange 317 that is operable to extend between at least a portion of the base surface 405 and the tooth surface 154. In this embodiment, bonding of the attachment device 400 and the tooth surface 154 is predominantly between the bonding material 174 and the cavity surface 415. FIG. 41 shows the attachment device 400 coupled to the tooth surface 154 after removal of the template 1200 and the gasket 300c wherein there may be defined a gap 255 between the tooth surface 154 and the base surface 405. This gap 255 may be filled with an appropriate fill material, such as, but not limited to, curable dental composite material and bonding material, after removal of the gasket 300c.

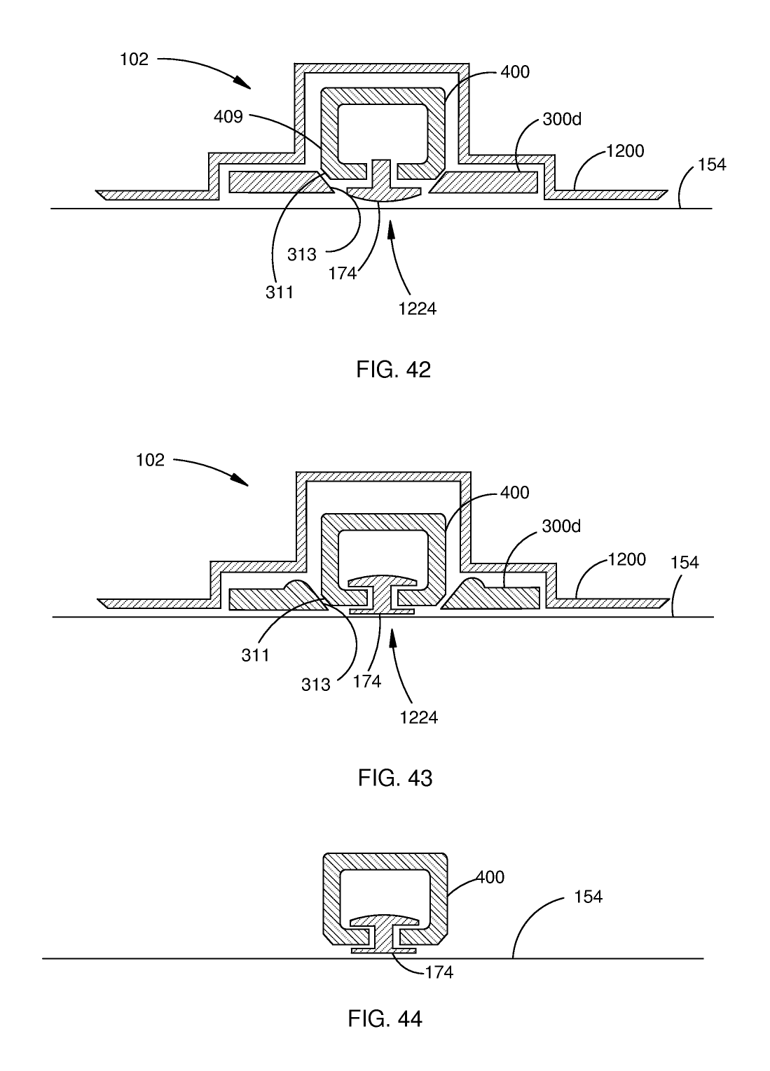

FIGS. 42-44 are cross-sectional views of the template 1200 at the attachment receiving cavity 1224, gasket 300d, and preformed attachment device 400, along cut-line 33-33 shown in FIG. 21, in accordance with another embodiment, in various stages of using the system 102. The preformed attachment device 400 is shown by way of example as the embodiment of FIG. 24. The gasket 300d is substantially the same as the gasket 300 of FIG. 33, but in this embodiment, the gasket aperture 310 defines, in cross-section, a gasket wedge 313. The base perimeter 409 correspondingly defines a base wedge 311 operable to define a pair of inclined planes set face-to-face operable to affect a fluid seal therebetween. Wherein the gasket 300d comprises an elastic material, the gasket 300d may deform or bulge, so as to affect the seal therebetween, as shown in FIG. 43.

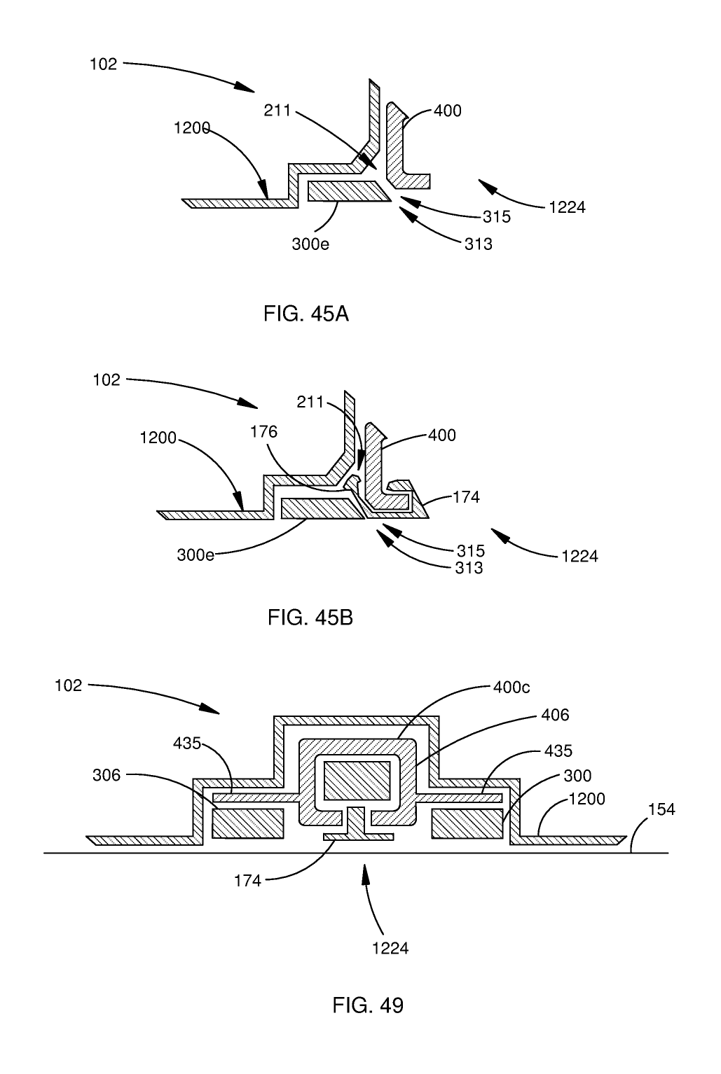

FIGS. 45A, 45B are partial cross-sectional views of the template 1200 at the attachment receiving cavity 1224, gasket 300e, and preformed attachment device 400, along cut-line 33-33 shown in FIG. 21, in accordance with another embodiment, in various stages of using the system 102. The gasket 300e is substantially the same as the gasket 300 of FIG. 33, but in this embodiment, the gasket aperture 310 defines, in cross-section, a gasket wedge 313. The base perimeter 409 correspondingly defines a base wedge 311 operable to define a pair of inclined planes set face-to-face operable to provide a fluid channel 315 therebetween. The fluid channel 315 is operable to provide a fluid path for excess bonding material 174 to extrude therethrough as a form of pressure relief that may be particularly beneficial for preformed attachment devices 400 having no internal pressure relief. The gasket cavity 210 defines a pocket 211 into which the excess bonding material 174 may flow from the fluid channel 315. Upon cure of the bonding material 174 and removal of the template 1200 and gasket 300e, the flash 176 of cured excess bonding material 174 may be readily removed as previously described for the embodiment of FIG. 14 as it will not be bonded to the tooth surface 154.

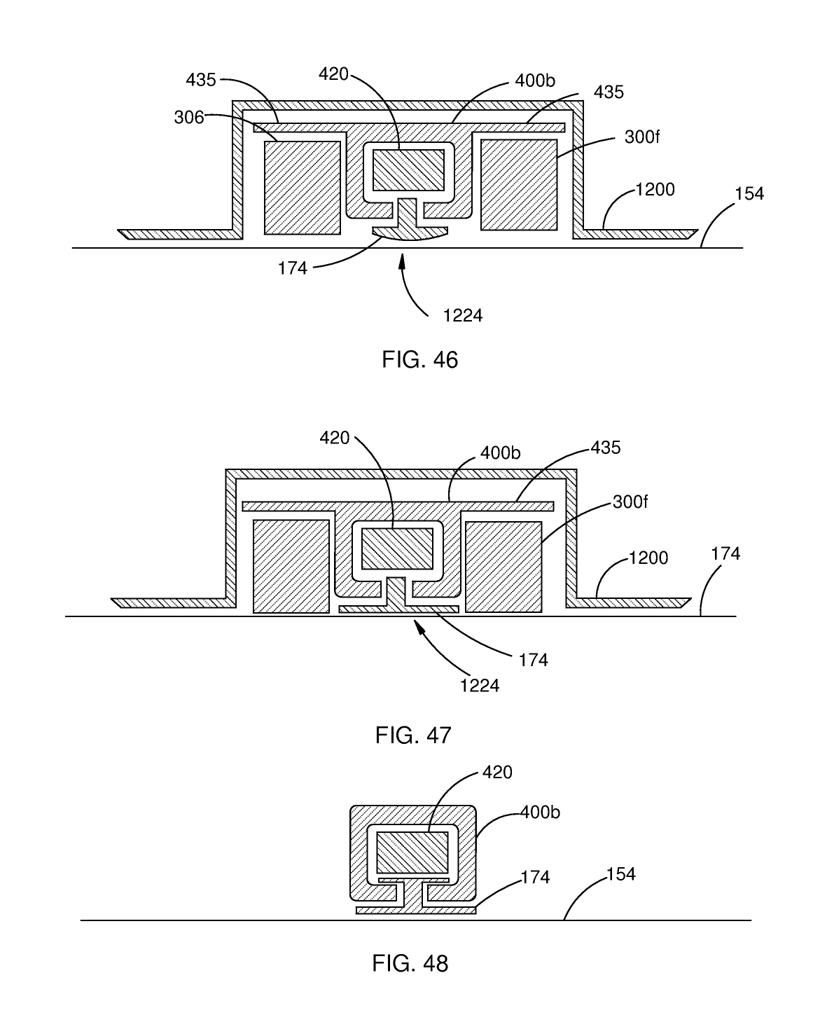

FIGS. 46-48 are cross-sectional views of the template 1200 at the attachment receiving cavity 1224, gasket 300f, and preformed attachment device 400b, along cut-line 33-33 shown in FIG. 21, in accordance with another embodiment, in various stages of using the system 102. The preformed attachment device 400b is shown by way of example as substantially the embodiment of FIG. 24 which further comprises an attachment flange 435 extending laterally from the top 404. The gasket 300f is substantially the same as the gasket 300b of FIG. 37. The attachment flange 435 is operable to engage the gasket second surface 306 of the gasket 300f so as to assist in advancing the gasket 300f to the tooth surface 154 when the preformed attachment device 400 is advanced towards the tooth surface 154.

FIG. 49 is a cross-sectional view of the template 1200 at the attachment receiving cavity 1224, gasket 300, and preformed attachment device 400c, along cut-line 33-33 shown in FIG. 21, in accordance with another embodiment. The preformed attachment device 400c is shown by way of example as substantially the embodiment of FIG. 24 which further comprises an attachment flange 435 extending laterally from the body 406. The attachment flange 435 is operable to engage the gasket second surface 306 of the gasket 300 so as to assist in advancing the gasket 300 to the tooth surface 154 when the preformed attachment device 400c is advanced towards the tooth surface 154.

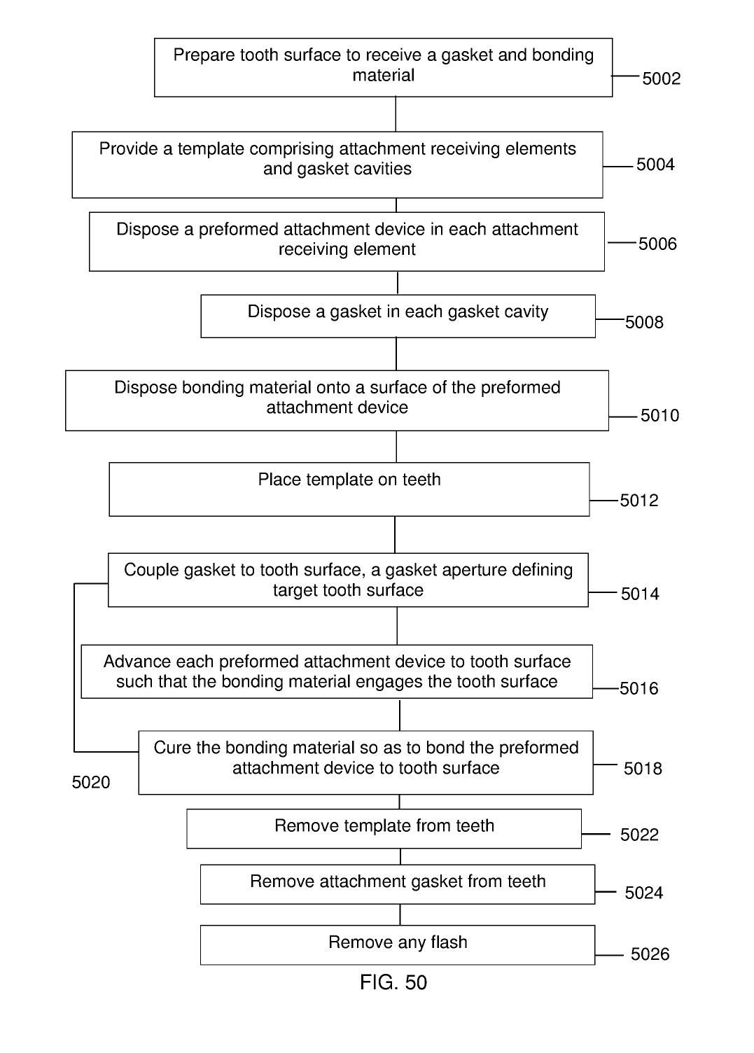

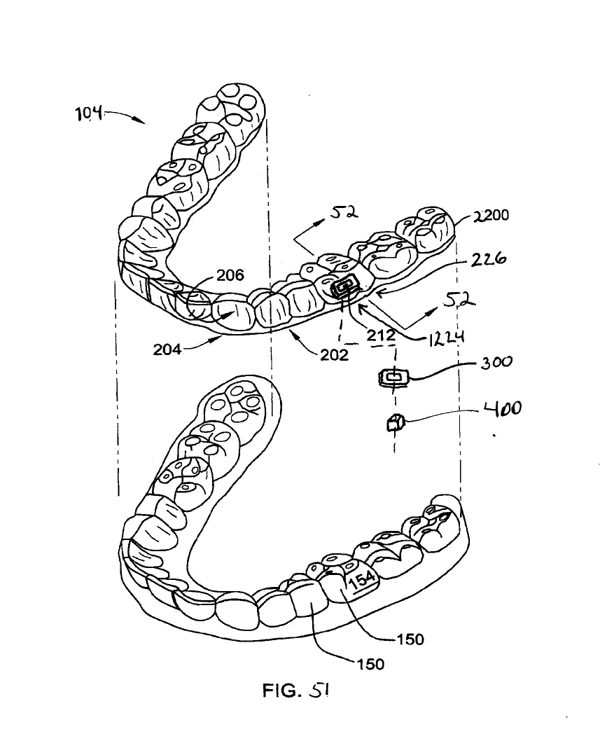

FIG. 50 is a flow chart of a method in accordance with an embodiment. The target tooth surface is suitably prepared to receive a gasket and bonding material, such as, but not limited to, cleaned, etched, rinsed, dried, and treated with bonding agent 5002. A template comprising a prescribed number and placement of attachment receiving elements and gasket cavities is provided 5004. A preformed attachment device is disposed into each of the attachment receiving cavities 5006. A gasket is disposed and removably coupled to each of the gasket cavities 5008. Bonding material is disposed onto a surface of the preformed attachment device 5010. The template is placed onto the teeth 5012. Each of the gaskets is removably coupled to the tooth surface, a gasket aperture defining target tooth surface 5014. Each of the preformed attachment devices is advanced to the target tooth surface such that the bonding material engages the target tooth surface 5016. The bonding material is cured so as to couple the preformed attachment device to the target tooth surface 5018. Additional preformed attachment devices are coupled to the teeth by repeating the process 5020. The template is removed from the teeth 5022. Each gasket is removed from the respective preformed attachment device and the teeth 5024. Any flash is removed 5026.

FIG. 51 is a perspective view of a system 104 for coupling preformed attachment devices onto one or more teeth 150, in accordance with an embodiment. In FIG. 51, the system 104 comprises a template 2200, one or more preformed attachment devices 400, and one or more gaskets 300. The system 104 is operable for accurate placement and secure bonding of preformed attachment devices 400 onto the tooth surface 154 without having bonding material 174 encroaching on unintended tooth surface 154 adjacent the preformed attachment device 400. The template 2200 is operable for accurate locating and positioning of the preformed attachment device 400 onto the tooth surface 154. The gasket 300 is operable to mask unintended tooth surface adjacent the preformed attachment device 400 from bonding material 174. The preformed attachment device 400 is operable to facilitate secure bonding to the tooth surface 154 so as to provide a desired cooperation with an oral appliance.

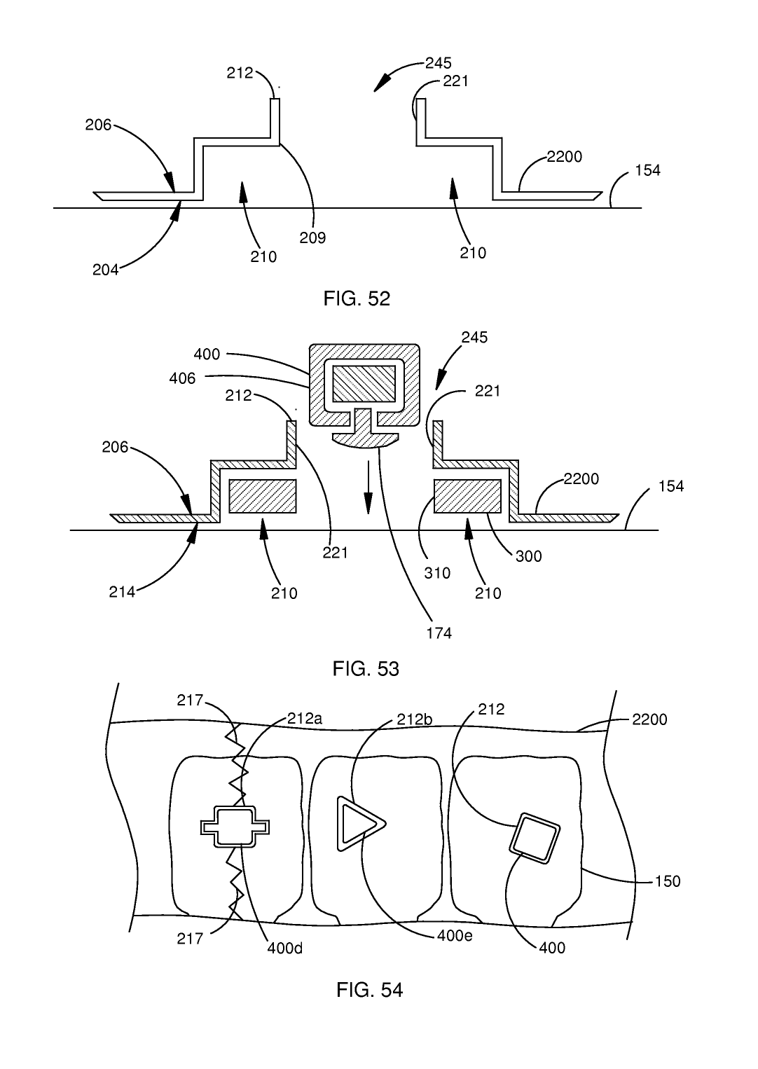

FIG. 52 is a cross-sectional view of the template 2200 at cut line 52-52 of the embodiment of FIG. 52. FIG. 53 is a cross-sectional view of the template 2200 at cut line 52-52 of the embodiment of FIG. 52 including a gasket 300 and a preformed attachment device 400, in accordance with an embodiment. The template 2200 of the embodiment of FIG. 51 is substantially the same as the template 1200 of the embodiment of FIG. 21. In contrast with the system 102 of FIG. 21 where the template 1200 comprises attachment receiving cavities 1224 operable for receiving preformed attachment devices 400, template 2200 comprises one or more attachment receiving elements 226 each comprising an attachment receiving guide 245 including a template aperture 212 extending from the template inner surface 204 to the template outer surface 206 therethrough. The template aperture 212 is operable to permit, after the template 2200 is coupled to the teeth 150, the disposition of a preformed attachment device 400 into the gasket aperture 310 and the advancement of the preformed attachment device 400 through the template aperture 212 and through the gasket aperture 310 to the tooth surface 154 as shown in FIG. 53.

The attachment receiving guide 245 comprises a gasket cavity 210 defining a concavity of the template 2200. The gasket cavity 210 is operable to receive a gasket 300 therein. Each attachment receiving guide 245 defines a guide wall 221 and defines the template aperture 212. The attachment receiving guide 245 is operable to guide the placement of the preformed attachment device 400 to provide accurate location and orientation onto the tooth surface 154.

The template comprises means for advancing each gasket into engagement with the tooth surface to affect a substantially fluid-sealing engagement therebetween with the gasket aperture defining target tooth surface. In accordance with embodiments of a method, the gasket 300 is advanced to the tooth surface 154 in substantially the same manner as previously described in discussion of the previous embodiments. In accordance with an embodiment of a method, the gasket 300 is advanced to and removably coupled with the tooth surface 154 prior to the placement and advancement of the preformed attachment device 400 through the attachment receiving guide 245.

In accordance with an embodiment, the size and shape of the template aperture 212 is operable to permit only a predetermined preformed attachment device 400 that has a corresponding size and shape to be placed through the respective template aperture 212. A particular unique size and/or shape of a preformed attachment device 400, such as defined by the body 406, 406a-c, such as shown in FIGS. 30A-C and 53, may be associated with a particular unique size and/or shape of a template aperture 212. Such an association may prevent the placement of an incorrect preformed attachment device 400 at a particular location on the teeth 150.

FIG. 54 is a partial side view of an embodiment of the template 2200 showing embodiments of various template apertures 212 associated with corresponding preformed attachment devices 400, 400d, 400e by way of example and not limited thereto. In FIG. 54, a first template aperture 212a comprises a square shape with a keyway corresponding to a complementary shape of a first preformed attachment device 400d, and a second template aperture 212b comprises a triangular shape corresponding to a complementary shape of a second preformed attachment device 400e. The template aperture 212 corresponds to the preformed attachment device 400, such as the embodiment of FIG. 23A, the template aperture 212 provided in a preferred orientation.

The uniqueness of the size and/or shape of the template aperture 212 having a particular size and/or shape of the body 406 of the preformed attachment device 400, among other things, alerts the practitioner that a correct or incorrect preformed attachment device 400 is being attempted at placement at a particular template aperture 212.

The attachment devices provided herein in combination with removable dental positioning appliances provide the patient with the benefits of removable appliances while enhancing the ability of those appliances to extrude, rotate, and otherwise manipulate teeth as is done with conventional braces. Embodiments provided herein provide a system that enables precise placement of an attachment device on a dental surface for a patient undergoing orthodontic repositioning.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

I claim:

1. A system for coupling an attachment device onto one or more teeth, comprising:
one or more preformed attachment devices each comprising a surface for receiving bonding material suitable for coupling the preformed attachment device to a tooth surface;
one or more gaskets each comprising a gasket first surface and a gasket second surface opposite the gasket first surface, the gasket further comprising a gasket aperture extending from the gasket first surface to the gasket second surface therethrough for receiving one of the one or more preformed attachment devices therein; and
a template comprising a cavity being operable to receive one or more teeth, the template further comprising an attachment receiving element and a gasket cavity at one or more predetermined locations, each attachment receiving element being operable to receive one of the one or more preformed attachment devices therein, each gasket cavity being operable to receive one of the one or more gaskets therein,
the template comprising means for advancing each gasket into engagement with the tooth surface to affect a substantially fluid-sealing engagement therebetween with the gasket aperture defining target tooth surface,
whereby each preformed attachment device may be advanced into engagement with the target tooth surface to affect coupling therewith via bonding material.

2. The system of claim 1, wherein the template being operable to removably couple with and dispose each gasket a predetermined distance away from the tooth surface during placement of the template onto the teeth,
the attachment receiving element comprising an attachment receiving cavity, the template being operable to removably couple with and dispose each preformed attachment device a predetermined distance away from the tooth surface during placement of the template onto the teeth such that any bonding material on the preformed attachment device does not come into contact with the tooth surface, and
the template comprising means for advancing each preformed attachment device into engagement with the target tooth surface to affect coupling therewith via bonding material.

3. The system of claim 1, the gasket further comprising a first adhesive layer disposed on the gasket first surface, the first adhesive layer being operable for removably coupling the gasket to the tooth surface in a substantially fluid-sealing engagement.

4. The system of claim 1, wherein each preformed attachment device comprises a base and a body extending from the base, the base comprising a base surface suitable for receiving bonding material thereon, each preformed attachment device further comprising an attachment cavity in communication with the base via an attachment aperture, the attachment aperture and attachment cavity are operable to receive bonding material that may extrude therein from adjacent the base.

5. The system of claim 4, wherein the attachment cavity comprises an attachment wall having a cavity surface, the preformed attachment device further comprising an internal flange that extends from the cavity surface adjacent the base, the internal flange defining the attachment aperture.

6. The system of claim 5, wherein the preformed attachment device further comprises a pressure relief element disposed within the attachment cavity, the pressure relief element being operable to facilitate movement of bonding material into the attachment cavity.

7. The system of claim 6, wherein the pressure relief element comprises a compressible material.

8. The system of claim 6, wherein the pressure relief element comprises a porous material.

9. The system of claim 4, wherein the attachment cavity comprises a first cavity and a second cavity, the second cavity in communication with the first cavity via a cavity aperture, the first cavity in communication with the attachment aperture.

10. The system of claim 5, wherein the preformed attachment device further comprises a pressure relief aperture defined by the attachment wall, the pressure relief aperture being operable to permit any air or bonding material to pass out of the attachment cavity and exit the preformed attachment device through the pressure relief aperture.

11. The system of claim 1, wherein each preformed attachment device comprises a base and a body extending from the base and an attachment top opposite the base, wherein the preformed attachment device further comprises an attachment flange extending laterally from the attachment top, the attachment flange being operable to engage the gasket second surface so as to assist in advancing the gasket to the tooth surface if the preformed attachment device is advanced towards the tooth surface.

12. The system of claim 1, wherein each preformed attachment device comprises a base and a body extending from the base and an attachment top opposite the base, wherein the preformed attachment device further comprises an attachment flange extending laterally from the body, the attachment flange being operable to engage the gasket second surface so as to assist in advancing the gasket to the tooth surface if the preformed attachment device is advanced towards the tooth surface.

13. The system of claim 3, wherein each gasket further comprises a second adhesive layer disposed on the gasket second surface, the second adhesive layer being operable for removably coupling the gasket to the gasket cavity, an adhesive strength of the first adhesive layer being stronger relative to the second adhesive layer such that the gasket will adhere to the tooth surface and decouple from the gasket cavity if the first adhesive layer is caused to contact the tooth surface.

14. The system of claim 2, wherein the gasket cavity and gasket cooperate so as to be in removable frictional engagement therebetween, and wherein the gasket and the preformed attachment device cooperate so as to be in removable frictional engagement therebetween.

15. The system of claim 14, wherein the gasket comprises an elastic material and is slightly oversized for the gasket cavity.

16. The system of claim 3, wherein the gasket further comprises a gasket outer wall opposite the gasket aperture, the gasket further comprising a third adhesive layer disposed on the gasket outer wall, the third adhesive layer being operable for removably coupling the gasket to the gasket cavity, an adhesive strength of the first adhesive layer being stronger relative to the third adhesive layer such that the gasket will adhere to the tooth surface and decouple from the gasket cavity if the first adhesive layer is caused to contact the tooth surface.

17. The system of claim 2, the template including a template inner surface and a template outer surface opposite the template inner surface, the attachment receiving cavity defining a stepped concavity of the template inner surface, the gasket cavity defining a stepped concavity of the template inner surface surrounding the attachment receiving cavity defining an attachment receiving cavity perimeter of the attachment receiving cavity, the template outer surface defining an attachment receiving cavity top surface opposite each attachment receiving cavity.

18. The system of claim 17, wherein the template adjacent the attachment receiving cavity is flexible such that the gasket and the preformed attachment device may be moved into contact with the tooth surface by urging the attachment receiving cavity top surface towards the tooth surface.

19. The system of claim 3, wherein the first adhesive layer is opaque to those light frequencies associated with light-curing bonding material which is curable by exposure to light-curing radiation, the first adhesive layer being operable to block light-curing radiation from illuminating between the gasket first surface and the tooth surface and therefore resist curing of any bonding material that may migrate between the gasket first surface and the tooth surface.

20. The system of claim 3, wherein the gasket is opaque to light frequencies associated with light-curing bonding material which is curable by exposure to light-curing radiation, the gasket being operable to block light-curing radiation from illuminating between the gasket and the tooth surface and therefore resist curing of any bonding material that may migrate between the gasket and the tooth surface.

21. The system of claim 1, wherein the gasket and preformed attachment device comprise a material that is at least partially transparent to light-curing radiation so as to permit transmission of light-curing radiation through the gasket and the preformed attachment device to bonding material that may be within the gasket aperture and preformed attachment device.

22. The system of claim 1, wherein each preformed attachment device comprises a base and a body extending from the base, the base defining a base perimeter, wherein the gasket aperture is operable to frictionally engage at least a portion of the body of the preformed attachment device about the base perimeter.

23. The system of claim 1, wherein each preformed attachment device comprises a base and a body extending from the base, the base defining a base perimeter, wherein the gasket aperture defines in cross-section a gasket wedge, the base perimeter of the preformed attachment device defines a complementary base wedge operable to engage the gasket wedge to affect a substantially fluid-sealing engagement therebetween.

24. The system of claim 1, wherein each preformed attachment device comprises a base and a body extending from the base, the base defining a base perimeter, wherein the gasket aperture defines in cross-section a gasket wedge, the base perimeter of the preformed attachment device defines a base wedge, the gasket wedge and base wedge being operable to define a pair of inclined planes positioned in face-to-face relationship being operable to provide a fluid channel therebetween, the fluid channel being operable to provide a fluid path for bonding material to extrude therethrough, the gasket cavity further comprising a pocket in fluid communication with the fluid channel into which the bonding material may flow from the fluid channel.

25. The system of claim 1, wherein the template further comprises frangible portions about the attachment receiving element being operable to provide for preferentially breaking apart so as to facilitate removal of the template from the preformed attachment device.

26. The system of claim 1, the template including a template inner surface and a template outer surface opposite the template inner surface, wherein the one or more attachment receiving elements comprise an attachment receiving guide comprising a template aperture extending from the template inner surface to the template outer surface therethrough, the attachment receiving guide being operable to cooperate with the preformed attachment device so as to guide the advancement of the preformed attachment device through the attachment receiving guide and the gasket aperture to the target tooth surface.

27. The system of claim 26, wherein the attachment receiving guide defines a size and shape that is operable to permit only a predetermined preformed attachment device that defines a corresponding size and shape to be placed through the respective template aperture.
